(19) United States
(12) Patent Application Publication
(10) Pub. No.: US 2026/0212459 A1
(43) Pub. Date: Jul. 23, 2026

(54) BLOOD SMEAR IMAGE STAIN NORMALIZATION METHOD, APPARATUS, DEVICE, AND STORAGE MEDIUM

(71) Applicant: JINFENG LABORATORY, Chongqing (CN)

(72) Inventors: Zheng WANG, Chongqing (CN); Jin CHEN, Chongqing (CN); Ke SUI, Chongqing (CN)

(73) Assignee: JINFENG LABORATORY, Chongqing (CN)

(21) Appl. No.: 19/454,414

(22) Filed: Jan. 21, 2026

(30) Foreign Application Priority Data
Jan. 22, 2025 (CN) 202510099269.8

(51) Int. Cl. G06T 5/60; G06T 3/40; G06T 5/50; G06T 7/13; G06T 11/60

(52) U.S. Cl. CPC G06T 5/60; G06T 3/40; G06T 5/50; G06T 7/13; G06T 11/60; G06T 2207/20004; G06T 2207/20036; G06T 2207/20084; G06T 2207/30024; G06T 2210/41

(57) ABSTRACT

A blood smear image staining normalization method, apparatus, device, and storage medium are provided. The method includes: extracting an illumination feature map and a first image based on a blood smear image and an illumination prior map; obtaining an enhanced image according to the first image and the illumination feature map; decomposing the enhanced image into a set of octave-spaced band-pass images and a low-resolution residual layer image; performing feature extraction on the low-resolution residual layer image to obtain a first feature map, extracting a first morphological representation and a staining contour based on the first feature map, and combining the first morphological representation with the staining contour to obtain a normalized low-resolution residual layer image; performing feature extraction on the band-pass images to obtain a second morphological representation, and combining the second morphological representation with the staining contour.

### CROSS REFERENCE TO THE RELATED APPLICATIONS

This application is based upon and claims priority to Chinese Patent Application No. 202510099269.8, filed on Jan. 22, 2025, the entire contents of which are incorporated herein by reference.

### TECHNICAL FIELD

The present application relates to the technical field of stain normalization for pathological images, and more particularly to a blood smear image stain normalization method, apparatus, device, and storage medium.

### BACKGROUND

In recent years, the development of Generative Adversarial Networks (GANs) has driven the emergence of various GAN-based H&E stain transfer methods. By using conditional generators, many existing frameworks are capable of transferring images from one or multiple staining domains to a designated target staining domain. In addition, the success of CycleGAN in unsupervised domain translation has encouraged the development of one-to-one and many-to-one stain transfer frameworks using cycle consistency.

The literature BenTaieb A, Hamarneh G. Adversarial stain transfer for histopathology image analysis, IEEE Transactions on Medical Imaging, 2017, 37(3): 792-802 designs a generative network that learns dataset-specific staining attributes and image-specific color transformations to achieve stain transfer. Inspired by CycleGAN, Shaban et al., “Staingan: Stain style transfer for digital histological images,” ISBI 2019 propose an end-to-end deep learning solution that transfers stain style from the source domain to the target domain.

CAGAN introduces a color-adaptive generative network for stain normalization, combining supervised learning in the target domain and unsupervised learning in the source domain to improve model performance. Liang et al., “Stain style transfer of histopathology images via structure-preserved generative learning,” 2020 propose two GAN-based stain style transfer models, SSIM-GAN and DSCSI-GAN. By incorporating structure-preserving metrics and auxiliary diagnostic network feedback, these models preserve medically relevant information—such as image texture, structure, and chromatic contrast—during stain normalization, and DSCSI-GAN is used to further improve normalization quality.

Vasiljevic et al., Neurocomputing, 2021 present an unsupervised augmentation method based on adversarial image-to-image translation to achieve realistic transformation between source and target domains. Wagner et al., MICCAI 2021 propose a novel color augmentation technique to simulate diverse histological staining styles, enabling stain-invariant training of neural networks. Mahapatra et al., MICCAI 2020 introduce a self-supervised approach that incorporates semantic information into a GAN-based stain normalization framework to preserve tissue structure.

However, GAN-based approaches require defining multiple staining domains corresponding to different laboratories, and they fail to generalize to unknown domains. Therefore, there is an urgent need for an algorithm capable of treating the full range of real staining variations as originating from a single domain, thereby eliminating reliance on domain labels and improving generalization for practical use.

Laplacian pyramid methods decompose an image into octave-spaced bandpass images and a low-resolution residual image and reconstruct the image through the low-frequency residual. These methods have been successfully applied in various deep learning tasks. Denton et al., 2015 employ a cascade of convolutional networks within a Laplacian pyramid framework to generate high-quality natural images in a coarse-to-fine manner, where each pyramid level trains a separate GAN to capture structures at that scale. Lin et al., CVPR 2021 introduce a Laplacian pyramid feed-forward strategy that transfers global style patterns at a low resolution and refines local details at a high resolution, producing stylized outputs by aggregating all pyramid levels.

Lai et al., CVPR 2017 propose a Laplacian pyramid network for progressive reconstruction of high-resolution images, predicting high-frequency residuals at each level and using transposed convolution for upsampling to finer scales. Liang et al., CVPR 2021 show that attribute transformations such as illumination and color adjustments correspond mostly to low-frequency components, whereas content details can be refined adaptively in high-frequency components. Based on this, they propose a Laplacian pyramid translation network that performs both tasks simultaneously and applies a progressive masking strategy for efficient high-frequency refinement.

Li et al., IEEE Transactions on Medical Imaging, 2023 propose a generative stain augmentation network that models real staining variations using a Laplacian pyramid-based generator architecture capable of disentangling stain representations from cellular morphology. However, this network lacks sufficient contextual information for spatial feature association. Furthermore, by treating degradation and normalization as a single process, the network encounters a performance bottleneck-since even the most advanced networks cannot simultaneously optimize for all tasks, performance must be sacrificed to balance competing objectives.

Although these methods can perform stain normalization to some extent, they suffer from the following limitations:
1. Traditional approaches rely on statistical characteristics of images for stain normalization, which requires strong statistical similarity between the source and target images and therefore exhibits poor generalization.
2. GAN-based approaches rely heavily on domain labels defined according to laboratory sources, and they cannot generalize to unknown domains.
3. Prior studies treat degradation and staining as a unified task, leading to performance bottlenecks and suboptimal processing results.
4. Existing methods are primarily designed for H&E images, while stain normalization research for blood smear images remains severely underdeveloped. Existing methods fail to simultaneously achieve (i) single-domain generalization, and (ii) structural invariance across multi-scale representations.

### SUMMARY

The present application provides a blood smear image stain normalization method, apparatus, device, and storage medium, so as to address the aforementioned technical problems.

According to a first aspect, the present application provides a blood smear image stain normalization method, including:
obtaining a blood smear image and an illumination prior map, merging the illumination prior map into the blood smear image, simulating the interaction among regions under different illumination conditions, extracting an illumination feature map, and aggregating the extracted illumination feature map to generate an illumination map; enhancing the blood smear image using the illumination map to obtain a first image;
obtaining an enhanced image based on the first image and the illumination feature map;
decomposing the enhanced image into a set of octave-spaced band-pass images and a low-resolution residual image;
performing feature extraction on the low-resolution residual image to obtain a first feature map, extracting a first morphological representation and a stain contour from the first feature map, and combining the first morphological representation with the stain contour to obtain a normalized low-resolution residual image;
performing feature extraction on the set of octave-spaced band-pass images to obtain a second morphological representation, and combining the second morphological representation with the stain contour to obtain normalized band-pass images.

According to one possible design, obtaining the blood smear image and the illumination prior map, merging the illumination prior map into the blood smear image, simulating the interaction among regions under different illumination conditions, extracting an illumination feature map, aggregating the illumination feature map to generate an illumination map, and enhancing the blood smear image using the illumination map to obtain the first image includes:
merging the blood smear image and the illumination prior map, fusing the illumination prior map into the blood smear image using pointwise convolution, simulating the interaction among regions under different illumination conditions using depthwise separable convolution, and further extracting features to generate the illumination feature map Fₗᵤ;
aggregating the illumination feature map Fₗᵤ using pointwise convolution to generate the illumination map;
decomposing the blood smear image into reflectance and illumination components according to the following equation:

$$S = R ∘ I \qquad ( 1 )$$

where S denotes the blood smear image, R denotes the reflectance component, I denotes the illumination component, and ∘ denotes element-wise multiplication;
introducing perturbations to the reflectance component and illumination component of the blood smear image to obtain an intermediate image, expressed as:

$$S 1 = ( R + \hat{R} ) ∘ ( I + \hat{I} ) = R ∘ I + R ∘ \hat{I} + \hat{R} ∘ ( I + \hat{I} ) \qquad ( 2 )$$

where S1 denotes the intermediate image, \hat{R} denotes the perturbation of the reflectance component, and Î denotes the perturbation of the illumination component;
multiplying the intermediate image by the illumination map to obtain:

$$S ∘ \overline{I} = R + R ∘ ( \hat{I} ∘ \overline{I} ) + ( \hat{R} ∘ ( I + \hat{I} ) ) ∘ \overline{I} \qquad ( 3 )$$

where Ī denotes the illumination map and Ī∘I=1; \hat{R}∘(I+Î) represents noise and artifacts amplified during the brightening of low-exposure images;
R∘(Î∘Ī) represents underexposure, overexposure, and/or color distortion caused during brightening;
simplifying Equation (3) yields:

$${S}_{lu} = S ∘ \overline{I} = R + C \qquad ( 4 )$$

where Sₗᵤ denotes the first image.

According to one possible design, the enhanced image is obtained based on the first image and the illumination feature map according to:

$${I}_{e n} = g ( {S}_{lu} , {F}_{lu} ) \qquad ( 5 )$$

where g denotes a degradation restorer, Iₑₙ denotes the enhanced image, Sₗᵤ denotes the first image, and Fₗᵤ denotes the illumination feature map.

According to one possible design, the degradation restorer includes an encoder and a decoder; the encoder is configured to downsample the input Sₗᵤ to match the dimensionality of Fₗᵤ and to reduce computational complexity while performing deep feature extraction. The downsampling process includes a first level and a second level, each consisting of an IFMT module and a 4×4 convolution module. After passing through the first and second downsampling levels, an intermediate feature map is obtained;
the decoder is configured to upsample the intermediate feature map. The upsampling includes a third level and a fourth level, each consisting of a 2×2 dconv module, a 1×1 convolution module, and an IFMT module. The output of the 2×2 dconv module is concatenated with the IFMT output of the corresponding downsampling level to alleviate information loss during downsampling. After the third and fourth upsampling levels, a second feature map is obtained, its dimensionality is adjusted back to RGB three channels to obtain a restored image, and the restored image is connected to the first image via residual connection to obtain the enhanced image.

According to one possible design, the IFMT module includes a first multi-head self-attention mechanism, a second multi-head self-attention mechanism, layer normalization, a feed-forward network, and residual connections.

The data processing of the first multi-head self-attention mechanism includes:
reshaping the input feature Fᵢₙ into a feature X;
splitting feature X into k heads according to:

$$X = [ {X}_{1} , {X}_{2} , … , {X}_{i} , … , {X}_{k} ] \qquad ( 6 )$$

where Xᵢ denotes the feature of the i-th head,

$${x}_{i} ∈ {ℝ}^{H W \times {d}_{k}} , {d}_{k} = \frac{c}{k} , i = 1 , 2 , … , k , ℝ$$

denotes the set of real numbers, H denotes image height, W denotes image width, dₖ denotes the dimensionality of each head, C denotes the number of channels;
for each headᵢ, projecting Xᵢ linearly into Qᵢ∈ [symbol] ^{HW×d}^{ₖ}, Kᵢ∈ [symbol] ^{HW×d}^{ₖ}, Vᵢ∈ [symbol] ^{HW×d}^{ₖ} using three bias-free fully connected layers:

$${Q}_{i} = {X}_{i} {W}_{{Q}_{i}}^{T} , {K}_{i} = {X}_{i} {W}_{{K}_{i}}^{T} , {V}_{i} = {X}_{i} {W}_{{V}_{i}}^{T} \qquad ( 7 )$$

where W_{Q}_{ᵢ}, W_{K}_{ᵢ}, W_{V}_{ᵢ}∈ [symbol] ^{d}^{ₖ}^{×d}^{ₖ} are learnable parameters, T denotes matrix transpose; Qᵢ, Kᵢ and Vᵢ denote query, key, and value, respectively;
using the illumination feature map Fₗᵤ as guidance for self-attention computation to enhance interactions among regions under different exposure levels, reshaping Fₗᵤ into Y E [symbol] ^{HW×C} and splitting Y into k heads:

$$Y = [ {Y}_{1} , {Y}_{2} , ⋯ , {Y}_{i} , ⋯ , {Y}_{k} ] \qquad ( 8 )$$

where Yᵢ represents the feature of the i-th head, Yᵢ∈ [symbol] ^{HW×d}^{ₖ}, i=1, 2, . . . , k;
the self-attention of each headį is expressed as:

$$Attention ( {Q}_{i} , {K}_{i} , {V}_{i} , {Y}_{i} ) = ( {Y}_{i} ∘ {V}_{i} ) softmax ( \frac{{K}_{i}^{T} {Q}_{i}}{{α}_{i}} ) \qquad ( 9 )$$

where αᵢ∈ [symbol] ¹ is a learnable parameter for adaptive scaling; concatenating the k heads and feeding them into a fully connected layer, adding a positional encoding P∈ [symbol] ^{HW×C} to obtain output tokens Xₒᵤₜ∈ [symbol] ^{HW×C};
reshaping Xₒᵤₜ to obtain output feature Fₒᵤₜ∈ [symbol] ^{H×W×C}.

The data processing of the second multi-head self-attention mechanism includes:
processing input features through a Linear layer and depthwise separable convolution, applying a SiLU activation function, and performing 2D scanning in four directions: up, down, left, and right; flattening the image such that height and width are merged as token length. Each sequence in the scan is fed into a feature extraction module for global feature extraction, expressed as:

$${h}_{t} = \overline{A} {h}_{t - 1} + \overline{B} {x}_{t}$$

$${y}_{t} = \overline{C} {h}_{t}$$

where xₜ denotes the input feature, yₜ denotes the output feature, Ā, B̅, and C̅ are learnable parameters, and hₜ denotes the state vector at time step t;
summing and merging the outputs y₁, y₂, y₃, and y₄ from the four directions and adjusting the output size to match the input feature size;
setting the number of hidden layers in the 2D scan to double with each increase in IFMT level such that deeper features can be extracted layer by layer from vectors containing integrated illumination features.

In one possible embodiment, the low-resolution residual image is subjected to feature extraction to obtain a first feature map. Based on the first feature map, a first morphological representation and a staining profile are extracted, and the first morphological representation is combined with the staining profile to obtain a normalized low-resolution residual image. The embodiment includes:
constructing a low-resolution residual network and a style network; wherein the low-resolution residual network is configured to perform feature extraction on the low-resolution residual image to obtain the first feature map, extract the first morphological representation based on the first feature map, and combine the first morphological representation with the staining profile to obtain the normalized low-resolution residual image; and the style network is configured to extract the staining profile based on the first feature map.

The low-resolution residual network obtains the normalized low-resolution residual image through the following procedure:
acquiring the low-resolution residual image; extracting features using two 3×3 convolution units and a LeakyReLU unit; performing deeper feature extraction through two residual self-attention modules; and finally obtaining the first feature map through a 3×3 convolution unit;
extracting the first morphological representation from the first feature map using a 3×3 convolution unit, an InstanceNorm2d unit, a LinearBlock unit, and a LeakyReLU unit, and combining the first morphological representation with the staining profile extracted by the style network; feeding the combined features into a generator, passing through two residual self-attention modules, followed by a 3×3 convolution unit, a LeakyReLU unit, and two 3×3 convolution units, to obtain the normalized low-resolution residual image (Î₃).

The style network includes an encoder module and a decoder module. The style network extracts the staining profile based on the first feature map through the following procedure:
in the encoder module, performing feature transformation on the first feature map using a Color Transform module composed of a 1×1 convolution, BatchNorm2d, and ReLU, so as to enhance the color consistency of the input features and reduce the influence of non-target style features on the generation of the style vector;
performing spatial feature compression using AdaptiveAvgPool2d to obtain a global feature representation; during the generation of the global feature representation, introducing a channel-attention mechanism to adaptively adjust channel importance, enabling the network to focus on features that significantly contribute to staining-style information; the encoder outputs a mean and variance, from which a style feature vector is generated using a VAE;
in the decoder module, reconstructing the style feature vector through a fully connected layer and further applying nonlinear transformation through an activation function to generate adaptive instance normalization parameters (αᵢ, βᵢ) representing the staining profile.

In a second aspect, the present application provides a blood smear image staining-standardization apparatus, including:
an image enhancement module, configured to acquire a blood smear image and an illumination prior map, merge the illumination prior map into the blood smear image, simulate interactions among regions under different illumination conditions, extract an illumination feature map, aggregate the extracted illumination feature map to generate an illumination map, and enhance the blood smear image using the illumination map to obtain a first image; and obtain an enhanced image based on the first image and the illumination feature map;
a staining-style unification module, configured to decompose the enhanced image into a set of octave-spaced band-pass images and a low-resolution residual image; perform feature extraction on the low-resolution residual image to obtain a first feature map, extract a first morphological representation and a staining profile based on the first feature map, and combine the first morphological representation with the staining profile to obtain a normalized low-resolution residual image; and perform feature extraction on the set of octave-spaced band-pass images to obtain a second morphological representation, and combine the second morphological representation with the staining profile to obtain normalized band-pass images.

In a third aspect, embodiments of the present application provide an electronic device, including at least one processor and a memory; the memory stores computer-executable instructions; the at least one processor executes the computer-executable instructions stored in the memory such that the at least one processor implements the blood smear image staining-standardization method according to the first aspect and any possible designs thereof.

In a fourth aspect, embodiments of the present application provide a computer-readable storage medium storing computer-executable instructions which, when executed by a processor, implement the blood smear image staining-standardization method according to the first aspect and any possible designs thereof.

In a fifth aspect, embodiments of the present application provide a computer program product including a computer program which, when executed by a processor, implements the blood smear image staining-standardization method according to the first aspect and any possible designs thereof.

The blood smear image staining-standardization method, apparatus, device, and storage medium provided in the present application achieve staining standardization of blood smear images.

On one hand, the application develops a decoupled deep attention model that separates the standardization task into two stages—low-quality image enhancement and staining-style unification—thus overcoming the performance limitations faced by existing algorithms that treat degradation and staining as a single coupled process.

On the other hand, the application constructs an attention-based Laplacian pyramid generative network to extract two independent representations from an input image: a cellular morphological representation as content and a staining profile as style. By combining a staining representation extracted from a reference image with the morphological representation of the input image, the method achieves staining standardization without altering intrinsic cellular structures.

In addition, an attention-based low-resolution residual network and a channel-attention-based style network are designed, which avoid the forgetting problem in deep networks and enable global awareness and adaptive weighting. The application treats the entire realistic staining appearance as originating from a single domain, thereby providing a new approach to overcome the dependence of generative adversarial networks on domain labels in staining-standardization tasks.

### BRIEF DESCRIPTION OF THE DRAWINGS

The accompanying drawings, which are incorporated in and constitute a part of the present specification, illustrate embodiments of the present application and, together with the description, serve to explain the principles of the present application.

FIG. 1 is a flowchart illustrating the blood smear image staining-standardization method according to embodiments of the present application;

FIG. 2 is an overall network framework diagram for implementing the blood smear image staining-standardization method according to embodiments of the present application;

FIG. 3 is a structural diagram of the Net1 network for low-quality image enhancement according to embodiments of the present application;

FIG. 4 is a schematic diagram illustrating the design details of the IFMT module according to embodiments of the present application;

FIG. 5 is a structural diagram of the Net2 network for staining-style unification according to embodiments of the present application;

FIG. 6 is an analysis diagram of each level in the Laplacian pyramid according to embodiments of the present application;

FIG. 7 is a structural diagram of the residual self-attention module according to embodiments of the present application;

FIGS. 8A-8G show a first visual comparison between the method of the present application and other methods on the SegPC2021 dataset;

FIGS. 9A-9G show a second visual comparison between the method of the present application and other methods on the SegPC2021 dataset;

FIGS. 10A-10R show a first visual comparison between the method of the present application and other methods in cell segmentation;

FIGS. 11A-11R show a second visual comparison between the method of the present application and other methods in cell segmentation;

FIGS. 12A-12R show a visual comparison between the method of the present application and other methods in multiple myeloma plasma cell segmentation;

FIG. 13 is a schematic structural diagram of the blood smear image staining-standardization apparatus according to embodiments of the present application;

FIG. 14 is a schematic structural diagram of an electronic device according to embodiments of the present application.

Through the drawings described above, illustrative embodiments of the present application are shown, and more detailed descriptions will be provided in the following sections. These drawings and the corresponding written description are intended to explain the concepts of the present application to those skilled in the art, rather than to limit the scope of the present application in any manner.

### DETAILED DESCRIPTION OF THE EMBODIMENTS

The exemplary embodiments are described in detail herein, and examples are illustrated in the accompanying drawings. When referring to the drawings, unless otherwise indicated, identical reference numerals refer to the same or similar elements across different figures. The embodiments described below do not represent all possible embodiments consistent with the present application. Rather, they are merely examples of devices and methods consistent with certain aspects of the present application as defined in the appended claims.

In the technical solutions of the present application, any collection, storage, use, processing, transmission, provision, or disclosure of financial data, user data, medical image data, and other information complies with applicable laws and regulations and does not violate public order or good morals.

It should be noted that certain software, components, models, or other technologies referenced in the embodiments of the present application may be solutions already available in the industry. They should be regarded as exemplary only, for the purpose of illustrating the feasibility of implementing the technical solutions of the present application, and do not imply that the applicant has used or necessarily will use such solutions.

The following specific embodiments describe the technical solutions of the present application and how these solutions address the aforementioned technical problems in detail. The embodiments below may be combined with one another, and concepts or processes that are the same or similar may not be repeated in every embodiment. The embodiments of the present application are described below with reference to the accompanying drawings.

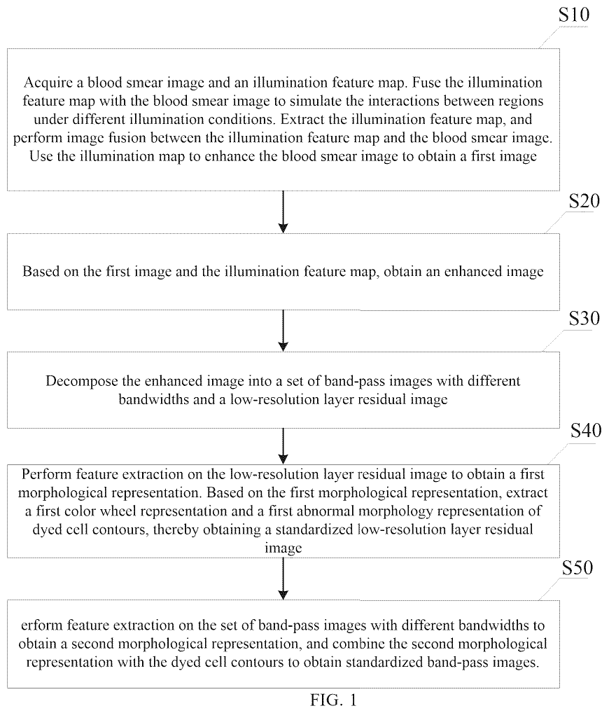

The present application provides a blood smear image staining method. FIG. 1 illustrates a flowchart of the blood smear image staining method according to an embodiment of the present application. As shown in FIG. 1, the blood smear image staining method may be implemented based on an electronic terminal, and includes steps S10 through S50.

S10: Acquire a blood smear image and an illumination prior map. The illumination prior map is fused into the blood smear image to simulate interactions among regions under different illumination conditions, extract an illumination feature map, aggregate the illumination feature map to generate an illumination map, and enhance the blood smear image using the illumination map to obtain a first image.

S20: Generate an enhanced image based on the first image and the illumination feature map.

S30: Decompose the enhanced image into a set of octave-spaced band-pass images and a low-resolution residual layer image.

S40: Perform feature extraction on the low-resolution residual layer image to obtain a first feature map. Extract a first morphological representation and a staining contour based on the first feature map, and combine the first morphological representation with the staining contour to obtain a standardized low-resolution residual layer image.

S50: Perform feature extraction on the octave-spaced band-pass images to obtain a second morphological representation, and combine the second morphological representation with the staining contour to obtain standardized band-pass images.

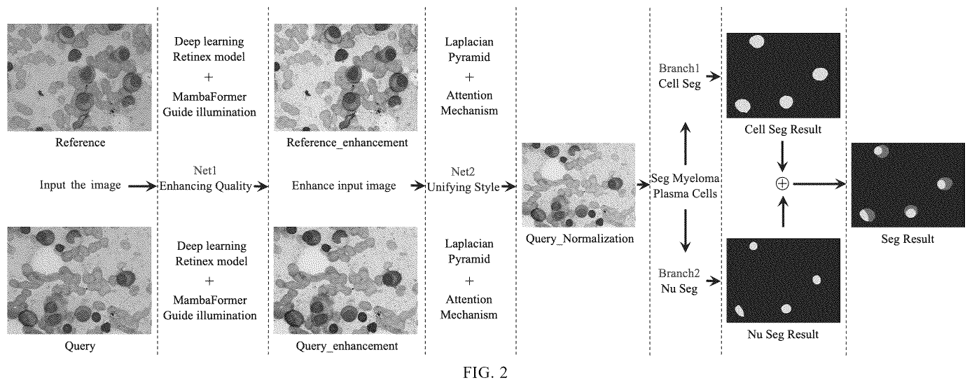

In this embodiment, the purpose of the blood smear image staining standardization method is to achieve staining standardization of blood smear images. A network framework is designed to implement steps S10 to S50, as shown in FIG. 2. In this framework, the staining standardization task is decoupled into two stages: low-quality image enhancement and staining style unification. The low-quality enhancement stage corresponds to steps S10-S20, while the staining style unification stage corresponds to steps S30-S50.

To implement staining standardization, two subnetworks—Net1 and Net2—are designed to model the two stages separately. Net1 is responsible for repairing images of varying quality, while Net2 is responsible for unifying staining styles. In addition, to evaluate the impact of the standardization algorithm on downstream tasks, a multiple myeloma plasma cell segmentation task is used for assessment. Two branches, Branch1 and Branch2, are employed to segment cells and nuclei respectively, and the two segmentation outputs are added to obtain the final segmentation result.

Net1 incorporates a Transformer and Mamba to develop a structure termed MambaFormer, which is embedded into a Retinex model to construct a low-quality image enhancement framework called RetinexMambaFormer. This framework maintains the long-range dependency modeling and non-local interaction capabilities of the Transformer while leveraging Mamba's selective mechanism to achieve linear-level global and local attention. Net2 combines a Laplacian pyramid and attention mechanisms to unify staining styles in a generative manner. Notably, this stage includes a residual attention-based low-resolution residual network to prevent forgetting in deep networks and to enable adaptive weight adjustment. A channel-attention-based style network is also designed to reassign weights using channel attention information, enabling more effective extraction of staining contours and improved standardization performance.

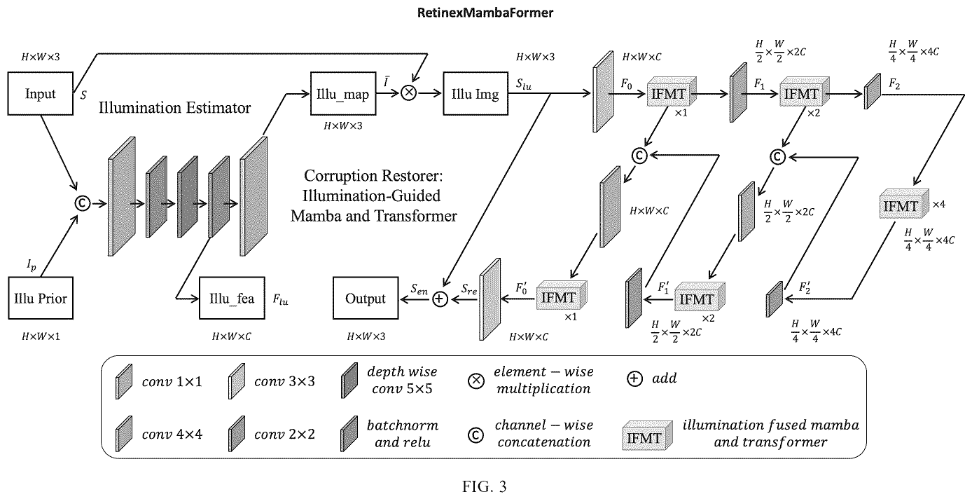

The overall structure of Net1 is shown in FIG. 3. Net1 consists of an illumination estimator (a) and a degradation restoration module (b). The illumination estimator is designed based on the Retinex model, while the degradation restoration module is constructed based on Illumination-Guided Mamba and Transformer (IGMT). As shown in FIG. 3, the core component of IGMT is the Illumination-Fused Mamba and Transformer (IFMT), which includes an illumination-guided multi-head self-attention mechanism, layer normalization, a Vision Mamba module, and a feed-forward network. The design details of the IFMT are illustrated in FIG. 4.

The traditional Retinex model decomposes an observed image S∈ [symbol] ^{H×W×3} into a reflectance component R∈ [symbol] ^{H×W×3} and an illumination component I∈ [symbol] ^{H×W}, The reflectance component represents the intrinsic properties of an object and is invariant to external factors, whereas the illumination component determines the image brightness:

$$S = R ∘ I \qquad ( 1 )$$

where ∘ denotes element-wise multiplication.

However, this theory ignores issues such as uneven light distribution in real exposure conditions or noise and artifacts generated under low-light environments, which are often excessively amplified during enhancement. Motivated by Retinex theory, the present embodiment adopts the perturbation terms introduced by RetinexFormer and incorporates perturbations into both reflectance and illumination components in Equation (1):

$$S 1 = ( R + \hat{R} ) ∘ ( I + \hat{I} ) = R ∘ I + R ∘ \hat{I} + \hat{R} ∘ ( I + \hat{I} ) \qquad ( 2 )$$

where \hat{R}∈ [symbol] ^{H×W×3} is the reflectance perturbation, and Î∈ [symbol] ^{H×W} is the illumination perturbation. Viewing Ras a well-exposed image, in order to enhance S1, both sides of Equation (2) are multiplied element-wise by the illumination map Ī, where Ī∘I=1:

$$R ∘ \overline{I} = R + R ∘ ( \hat{I} ∘ \overline{I} ) + ( \hat{R} ∘ ( I + \hat{I} ) ) ∘ \overline{I} \qquad ( 3 )$$

Here, \hat{R}∘(I+Î) represents noise and artifacts amplified during the rightening of low-exposure images, and R∘(Î∘Ī) represents under-xposure, over-exposure, or color distortion introduced during the brightening process.

Based on this, Equation (3) can be simplified as:

$${S}_{lu} = S ∘ \overline{I} = R + C \qquad ( 4 )$$

where Sₗᵤ∈ [symbol] ^{H×W×3} is the first image (the lit-up image), C∈ [symbol] ^{H×W×3} represents the aforementioned degradations. Thus, the processing of Net1 can be formulated as:

$$( {S}_{lu} , {F}_{lu} ) = f ( S , {I}_{p} ) \qquad ( 5 )$$

$${I}_{en} = g ( {S}_{lu} , {F}_{lu} )$$

Where f(⋅) denotes the illumination estimator and g(⋅) denotes the degradation restoration module. The illumination estimator f(⋅) takes as input the low-quality image S and illumination prior and outputs the lit-up image Sₗᵤ and illumination feature map Fₗᵤ∈ [symbol] ^{H×W×C}. Here, Iₚ=mean_{c}(S), where mean_{c}(⋅) computes the per-pixel mean across all color channels. Subsequently, Sₗᵤ and Fₗᵤ are fed into g(⋅) to repair degradations amplified during brightening and to generate the final enhanced image

$${I}_{en} ∈ {ℝ}^{H \times W \times 3}$$

Illumination estimator The design details of the illumination estimator are shown in FIG. 3. The low-quality image S and illumination prior Iₚ are first fused, and a 1×1 convolution (conv 1×1) is applied to embed Iₚ into S. A 5×5 depthwise separable convolution is then used to simulate interactions among regions under different illumination conditions, extracting features to generate the illumination feature map Fₗᵤ. Another conv 1×1 is then used to aggregate Fₗᵤ and produce the illumination map I. The illumination map Ī is set as a three-channel RGB tensor to enhance its capability in modeling nonlinear relationships among RGB channels and improve color enhancement.

To ensure effective feature extraction, stable training, and faster convergence, Batch Normalization layers are applied after both the first conv 1×1 and the 5×5 depthwise separable convolution, followed by ReLU activation to improve nonlinear expressiveness.

Degradation Restoration Module The degradation restoration module, shown in FIG. 3, consists of an encoder-decoder structure based on Illumination-Guided Mamba and Transformer. The encoder and decoder correspond to downsampling and upsampling processes respectively, and are symmetric with two levels.

First, a 3×3 convolution downsamples the lit-up image Stu obtained from f(⋅) to match the dimensionality of Fₗᵤ. Downsampling reduces computational complexity and enables deep feature extraction. Each level of the downsampling stage consists of the proposed Illumination-Guided Mamba and Transformer (IFMT, i.e., the MambaFormer structure) followed by a 4×4 convolution with stride 2. After each convolution, image size is halved and feature dimensions doubled. Thus, after two levels, the feature dimension becomes 4C.

After downsampling, upsampling is performed to reconstruct the image. Similar to downsampling, upsampling also has two levels. Each level includes a 2×2 deconvolution (dconv) with stride 2, a conv 1×1 layer, and an IFMT module. After each dconv, the spatial dimensions are doubled while the feature dimension is halved. The output of each dconv is concatenated with the corresponding IFMT output from the downsampling path to mitigate information loss.

Finally, a 3×3 convolution reduces feature dimensionality and restores the RGB three-channel output, generating the repaired image Sᵣₑ. A residual connection is applied between Sᵣₑ and Sₗᵤ to obtain the final enhanced image Sₑₙ.

Compared with traditional methods, CNN-based approaches demonstrate significant performance advantages, yet they remain insufficient in capturing long-range dependencies. Transformer-based methods, on the other hand, suffer from extremely high computational complexity. Thus, several hybrid CNN-Transformer works only employ Transformer layers in the bottleneck stage of the U-Net architecture, leaving the full potential of the Transformer insufficiently exploited. To fully unlock the capability of the Transformer, the present embodiment proposes an Illumination Fused Mamba and Transformer (IFMT) structure. The design details of IFMT are illustrated in FIG. 4.

A classical Transformer consists of two multi-head self-attention modules, layer normalization, a feed-forward network, and residual connections. To reduce the computational complexity associated with capturing long-range dependencies, the present embodiment replaces the two multi-head self-attention modules with an illumination-guided multi-head self-attention mechanism and a Vision Mamba module (i.e., the first and second multi-head self-attention mechanisms). This allows the model to retain the advantages of the Transformer architecture while benefiting from the global and local modeling efficiency of Mamba, which operates in linear time.

As shown in FIG. 4, the feature map Fₗᵤ obtained by f(⋅) is fed into the illumination-guided multi-head self-attention module. To alleviate the substantial computational burden of conventional multi-head attention, the illumination-guided mechanism treats each channel of the feature map as a token when computing self-attention.

First, the input feature Fᵢₙ∈ [symbol] ^{H×W×C} was reshaped into X∈ [symbol] ^{HW×C}, the feature X is then split into k heads:

$$X = [ {X}_{1} , {X}_{2} , ⋯ , {X}_{i} , ⋯ , {X}_{k} ] \qquad ( 6 )$$

where Xᵢ represents the feature of the i-th head,

$${d}_{k} = \frac{C}{k} ,$$

and i=1, 2, . . . , k. FIG. 3 illustrates the case of k=1, with certain details omitted for simplicity.

For each headᵢ, three bias-free fully connected layers project Xᵢ linearly into
Qᵢ∈ [symbol] ^{HW×d}^{ₖ}, Kᵢ∈ [symbol] ^{HW×d}^{ₖ}, Vᵢ∈ [symbol] ^{HW×d}^{ₖ}:

$${Q}_{i} = {X}_{i} {W}_{{Q}_{i}}^{T} , {K}_{i} = {X}_{i} {W}_{{K}_{i}}^{T} , {V}_{i} = {X}_{i} {W}_{{V}_{i}}^{T} \qquad ( 7 )$$

where Qᵢ, Kᵢ, and Vᵢ denotes query, key and value, respectively; W_{Q}_{ᵢ}, W_{K}_{ᵢ}, W_{V}_{ᵢ}∈ [symbol] ^{d}^{ₖ}^{×d}^{ₖ} are learnable parameters, and T denotes the matrix transpose.

It is understood that illumination information in an image is not uniformly distributed; regions exhibit varying intensity levels, and degradation is more pronounced in under-exposed areas. These regions are also more challenging to restore. Well-exposed regions typically retain semantic contextual information that can facilitate the restoration of under-exposed regions. Therefore, the present embodiment employs Fₗᵤ as guidance for the self-attention computation to enhance interactions between regions with different exposure levels.

To ensure consistent dimensionality with X, the illumination feature Fₗᵤ is reshaped into Y∈ [symbol] ^{HW×C}, and split into k heads:

$$Y = [ {Y}_{1} , {Y}_{2} , ⋯ , {Y}_{i} , ⋯ , {Y}_{k} ] \qquad ( 8 )$$

where Yᵢ∈ [symbol] ^{HW×d}^{ₖ}, i=1, 2, . . . , k, corresponds to the i-th head.

The self-attention of each headᵢ is computed as follows:

$$Attention ( {Q}_{i} , {K}_{i} , {V}_{i} , {Y}_{i} ) = ( {Y}_{i} ∘ {V}_{i} ) softmax ( \frac{{K}_{i}^{T} {Q}_{i}}{{α}_{i}} ) \qquad ( 9 )$$

where αᵢ∈ [symbol] ¹ is a learnable parameter adaptively scaling the matrix multiplication, and ∘ denotes element-wise multiplication.

The outputs of all kheads are concatenated and fed into a fully connected layer, after which learnable positional encodings P∈ [symbol] ^{HW×C} are added to obtain the output tokens Xₒᵤₜ∈ [symbol] ^{HW×C}. Finally, Xₒᵤₜ is reshaped back into Fₒᵤₜ∈ [symbol] ^{H×W×C}. The computational complexity of this design mainly arises from the two matrix multiplications computed k times in Equation (10): [symbol] ^{d}^{ₖ}^{×HW}× [symbol] ^{HW×d}^{ₖ} [symbol] [symbol] ^{HW×d}^{ₖ}× [symbol] ^{d}^{_{k×HW}}, The time complexity can be expressed as:

$$ϑ = k \cdot [ {d}_{k} \cdot ( {d}_{k} \cdot HW ) + HW \cdot ( {d}_{k} \cdot {d}_{k} ) ] = 2 {HWkd}_{k}^{2} = 2 {HWk ( \frac{C}{k} )}^{2} = \frac{2 {HWC}^{2}}{k}$$

Therefore, the illumination-guided multi-head self-attention mechanism designed in the present embodiment exhibits computational complexity linearly proportional to spatial resolution, significantly reducing the computation cost associated with Transformer architectures.

Vision Mamba Inspired by selective state-space models, the Vision Mamba module is integrated into the framework in the present embodiment and replaces the second multi-head self-attention mechanism in the classical Transformer architecture. The Vision Mamba consists of a linear layer, depthwise separable convolution, SiLU activation, 2D scanning, normalization, and residual connections. First, the input features are processed through a linear layer and a depthwise separable convolution, followed by a SiLU activation. A 2D scanning operation is then performed to expand the features in four directions—top, bottom, left, and right. After the image is flattened, its height (H) and width (W) are merged into the token length (L). Each sequence produced by the 2D scan is subsequently fed into a feature extraction module for global representation learning, which can be expressed by the following equations:

$${h}_{t} = \overline{A} {h}_{t - 1} + \overline{B} {x}_{t}$$

$${y}_{t} = \overline{C} {h}_{t}$$

where xₜ denotes the input feature, yₜ denotes the output feature, Ā, B̅, and C̅ represent learnable parameters, and hₜ represents the state vector at time step t.

The four directional outputs y₁, y₂, y₃, and y₄ are then summed and merged, and the output feature is reshaped to match the spatial dimensions of the input. Furthermore, to extract deeper latent representations, the number of hidden layers in the 2D scanning module is configured to double as the level of the IFMT increases. As an example, the initial number of hidden layers dₛₜₐₜₑ in the 2D scanning module may be set to 16, and this value is doubled at each deeper sampling level, reaching 64 at the deepest sampling stage. This configuration enables progressive extraction of deeper features from the illumination-integrated vector representations.

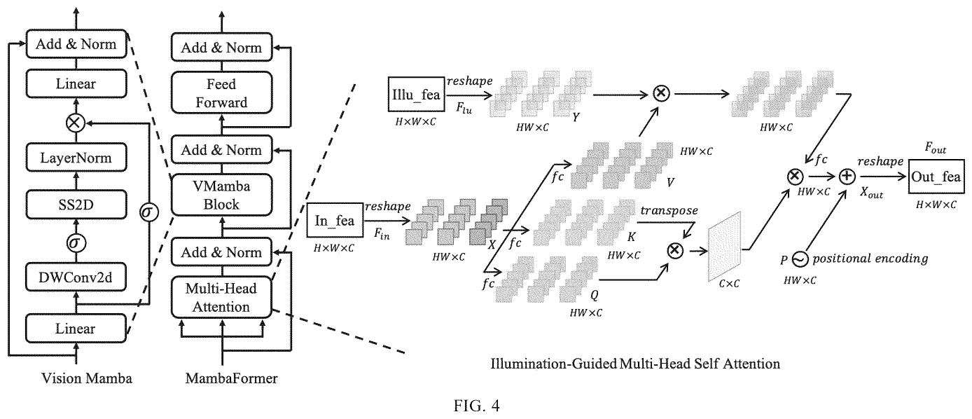

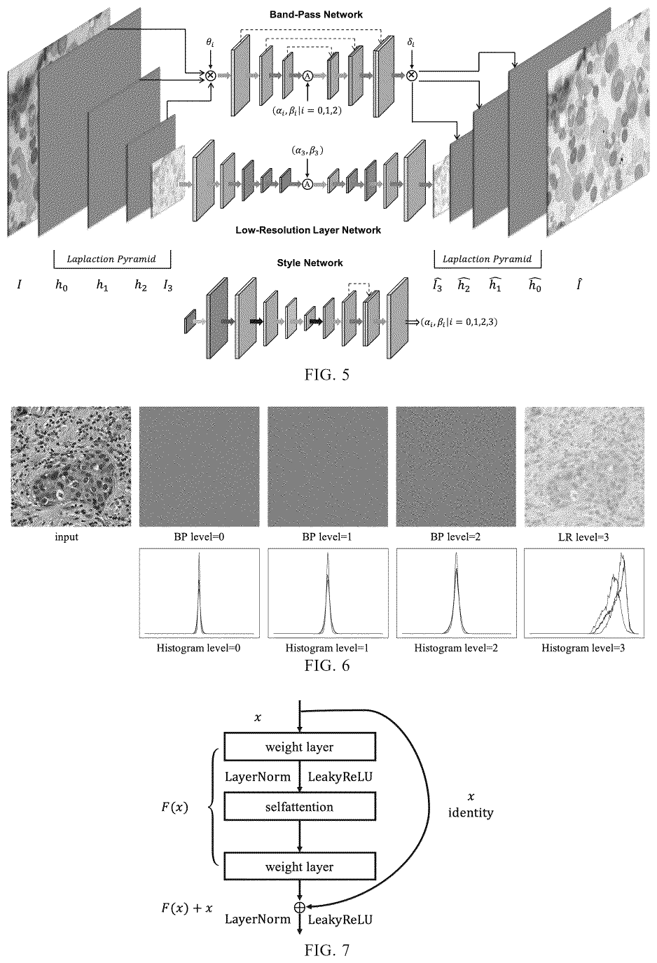

Net1 enhances the quality of the input image; however, due to its decoupled design philosophy, Net1 only addresses degradation-related issues and does not account for stain-related variations. Therefore, Net2 is designed to further standardize stain appearance, thereby achieving complete stain normalization. The overall architecture of Net2 is shown in FIG. 5. Net2 is a generative network combining an attention mechanism with a Laplacian pyramid. Net2 includes a Laplacian pyramid, a bandpass network, a low-resolution residual network, and a style network. Both the bandpass network and the low-resolution residual network follow an encoder-generator structure. The encoder in the low-resolution residual network extracts cellular morphology as content, while the style network extracts staining contour as style. The staining representation extracted from a reference image is then fused with the morphological representation of the input image to achieve stain normalization without altering underlying cellular structures.

Laplacian Pyramid The Laplacian pyramid (LP) decomposes an image into a set of octave-spaced bandpass images and one low-resolution residual image. The statistical characteristics of these two types of components are analyzed through histogram inspection, as shown in FIG. 6. The analysis indicates that the bandpass images primarily capture the high-frequency details of the image and are insensitive to color information, whereas the stain and content characteristics are mainly represented in the low-resolution residual image. Based on this observation, a lightweight network is sufficient for fine-tuning the bandpass images, while the more detailed processing should focus on the low-resolution residual network. This design greatly clarifies the network structure and assigns a clear functional objective to each module.

Low-Resolution Residual Network As described above, the design of the low-resolution residual network plays a critical role in effectively separating content and style. To address the issue of information loss at deeper network layers, residual modules are employed. Additionally, a self-attention mechanism is introduced to capture global information and adaptively adjust feature weights. The self-attention mechanism is embedded into the residual blocks to form a residual self-attention module for deep feature processing and adaptive weight adjustment, as illustrated in FIG. 7.

The low-resolution residual image I₃ obtained from LP decomposition is fed into the low-resolution residual network. First, two 3×3 convolution layers followed by LeakyReLU are used for feature extraction. Two residual self-attention modules are then applied for deeper feature processing. Finally, a 3×3 convolution is used to obtain the LR Image Encoder Feature.

To achieve more effective stain normalization, the morphological representation is combined with the staining contour extracted from the style network via a 3×3 convolution, InstanceNorm2d, LinearBlock, and LeakyReLU. The fused representation is then fed into the generator, which consists of two residual self-attention modules, followed by a 3×3 convolution, LeakyReLU, and two additional 3×3 convolution layers, producing the stained low-resolution residual image Î₃.

Style Network To disentangle cellular morphology from staining contour, a style network is designed to process the LR Image Encoder Feature. The style network consists of an encoding module and a decoding module, corresponding to stain feature extraction and parameter generation, respectively.

In the encoding module, a Color Transform module composed of a 1×1 convolution, BatchNorm2d, and ReLU first transforms the LR Image Encoder Feature to enhance color consistency and reduce interference from non-target style attributes. AdaptiveAvgPool2d is then applied to compress spatial dimensions and obtain global representations. During style vector generation, a channel attention mechanism is introduced to adaptively adjust channel importance, enabling the network to focus on features that significantly contribute to staining style while suppressing irrelevant or secondary features. The encoder outputs the mean and variance parameters, which are used by a VAE to construct the style feature vector.

In the decoding module, the style vector is reconstructed using a fully connected layer, followed by a nonlinear activation function, to generate the adaptive instance normalization (AdaIN) parameters (αᵢ, βᵢ) that represent the staining contour.

Bandpass Network Because bandpass images primarily represent high-frequency information and are insensitive to color, only a lightweight network is required for adjustment. The inputs to the bandpass network are bandpass images h₀, h₁, and h₂. Similar to the low-resolution residual network, each bandpass image is processed by an encoder to extract morphological representation, which is then combined with the AdaIN parameters (αᵢ, βᵢ) extracted by the style network to perform stain transfer. The generator produces the outputs h₀, h₁, and h₂.

Additionally, a pyramid feature fusion mechanism is introduced. For each bandpass layer, the current bandpass feature is added to the pyramid feature propagated from the previous layer. This design injects contextual information during bandpass refinement, reinforcing inter-layer feature dependency and improving global structural perception while preserving detailed textures.

Furthermore, because bandpass images typically have a mean of 0 and a standard deviation significantly smaller than that of the low-resolution residual image, non-learnable parameters θᵢ and δᵢ are introduced to scale the inputs and outputs of the bandpass network to the range (−1, 1), thereby facilitating more stable network learning.

In the following embodiments, the method proposed in the present application is qualitatively evaluated and further validated on a downstream task—myeloma plasma cell segmentation—to demonstrate its feasibility and advancements.

### 1) Qualitative Evaluation

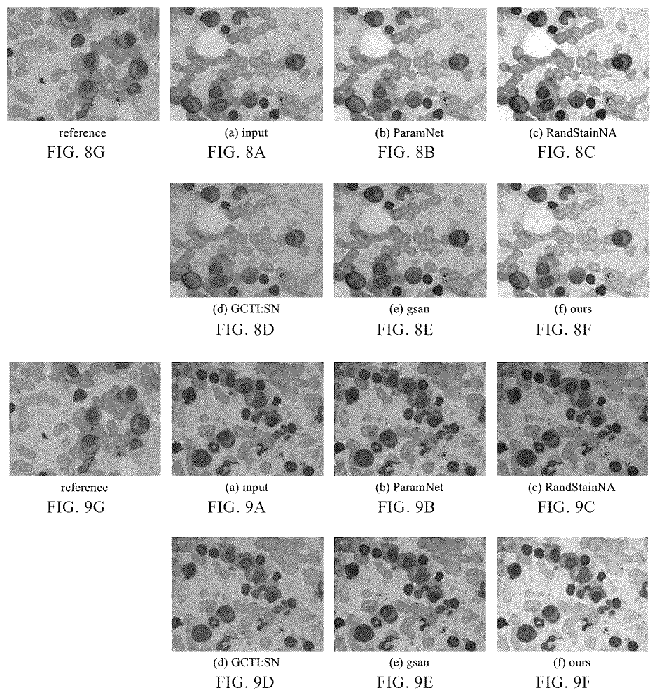

FIGS. 8A-8G and FIGS. 9A-9G illustrate the visual comparison of staining normalization results obtained using the method proposed in the present application and other existing methods. Among them, ParamNet and RandStainNA are algorithms developed for H&E stain normalization, GCTI:SN is designed for stain normalization in blood smears, and gsan serves as a general staining architecture. As shown in the results, ParamNet and RandStainNA fail to achieve the goal of stain normalization. As discussed earlier, most existing stain normalization methods are designed specifically for H&E images and cannot be directly applied to blood smear images; stain normalization algorithms applicable to blood smears are severely lacking. This observation is further supported by the results shown in FIGS. 8A-8G and FIGS. 9A-9G, particularly in FIGS. 8B-8C and FIGS. 9B-9C.

GCTI:SN corrects illumination variations during stain normalization. However, jointly addressing both illumination correction and stain normalization leaves room for improvement in the final visual appearance. Furthermore, the quality of the reference image directly affects the normalization results. When a low-quality image is used as reference, even illumination correction cannot guarantee satisfactory staining consistency, as demonstrated in FIG. 8D and FIG. 9D.

Benefiting from its principle of separating content and style, gsan can be applied to both H&E and blood smear images as a general framework. However, it treats standardization and degradation as a single joint problem, which inevitably compromises network performance since even a strong model cannot effectively handle multiple complex tasks simultaneously without trade-offs. Additionally, gsan ignores the importance of attention mechanisms within the Laplacian pyramid. Particularly in the extraction of cellular morphology and staining contours, attention is crucial for providing more precise feature representations and capturing information effectively, thereby improving detail processing and global consistency—factors essential for accurate extraction of morphology and staining patterns.

The method proposed in the present application adopts a decoupled design that divides the stain normalization task into two stages: low-quality image enhancement and stain style unification. This decomposition simplifies the overall task by allowing each subnetwork to focus solely on its dedicated objective. Prior to stain unification, degraded or uneven-quality images are restored, providing high-quality and consistent data for subsequent stain unification. During the stain unification stage, attention modules are incorporated to enhance adaptive feature extraction. As shown in FIG. 8F and FIG. 9F, the proposed method not only achieves effective stain normalization but also significantly enhances image quality.

### 2) Downstream Task—Myeloma Plasma Cell Segmentation

The performance of the proposed method has been sufficiently validated through qualitative evaluation. To further assess the effectiveness of the proposed method from a quantitative perspective, myeloma plasma cell segmentation is selected as a downstream task. As discussed earlier, only GCTI:SN and gsan are applicable to blood smear images; therefore, the comparison in the downstream task is limited to these two methods.

This embodiment employs the mean Intersection over Union (mIoU) and Aggregated Jaccard Index (AJI) as segmentation performance metrics. mIoU measures the overlap between model predictions and ground truth, while AJI evaluates instance segmentation performance by considering both segmentation precision and region coverage. Together, these metrics provide a comprehensive evaluation of algorithm performance and robustness across semantic and instance segmentation tasks. Branch1 and Branch2 are used for segmenting cells and nuclei, respectively. The two segmentation results are then combined to obtain the final segmentation result.

Table 1 shows the performance comparison among the proposed method, GCTI:SN, and gsan for cell, nucleus, and myeloma plasma cell segmentation.

TABLE 1
Comparison of Segmentation Metrics in the Downstream Task

| | | mIoU | | | AJI | |
|---|---|---|---|---|---|---|
| Method | cell | nu | MPC | cell | nu | MPC |
| input | 0.6770 | 0.6848 | 0.6770 | 0.5208 | 0.5293 | 0.5208 |
| GCTI:SN | 0.7509 | 0.7595 | 0.7509 | 0.6143 | 0.6304 | 0.6143 |
| gsan | 0.6860 | 0.7068 | 0.6860 | 0.5301 | 0.5627 | 0.5301 |
| Proposed | 0.8177 | 0.8183 | 0.8177 | 0.7067 | 0.7129 | 0.7067 |
| method | | | | | | |

Experimental results indicate that the proposed method outperforms existing advanced methods, achieving superior mIoU and AJI scores. Compared with the raw input, gsan yields improvements, indicating that stain normalization significantly impacts downstream performance. However, due to its omission of attention information in morphology and stain contour extraction, its performance gains are limited. GCTI:SN achieves substantial improvement because of its illumination correction mechanism; however, treating illumination correction and staining as a unified operation limits further enhancement. Moreover, when a low-quality reference image is used, illumination correction may degrade performance.

The proposed method effectively overcomes these limitations and achieves optimal results in both mIoU and AJI.

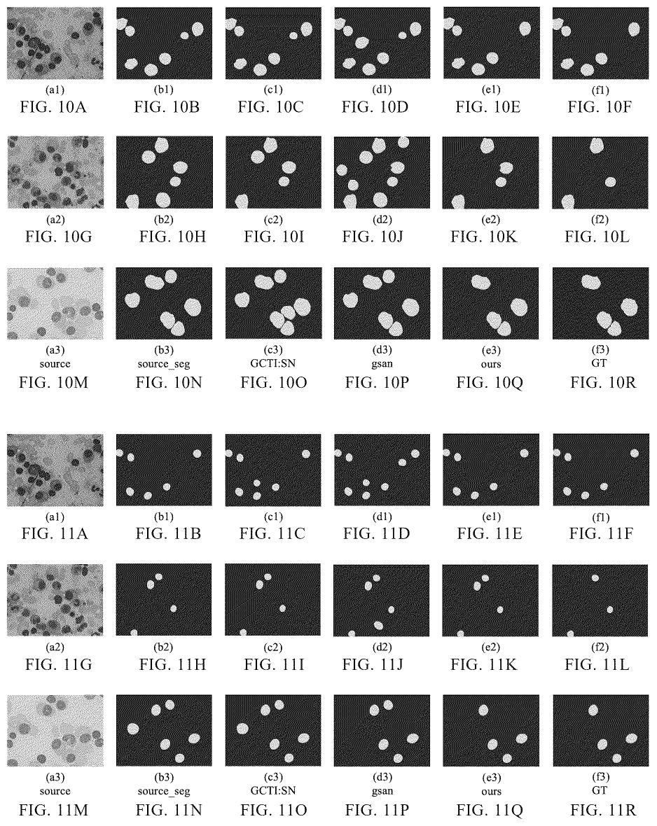

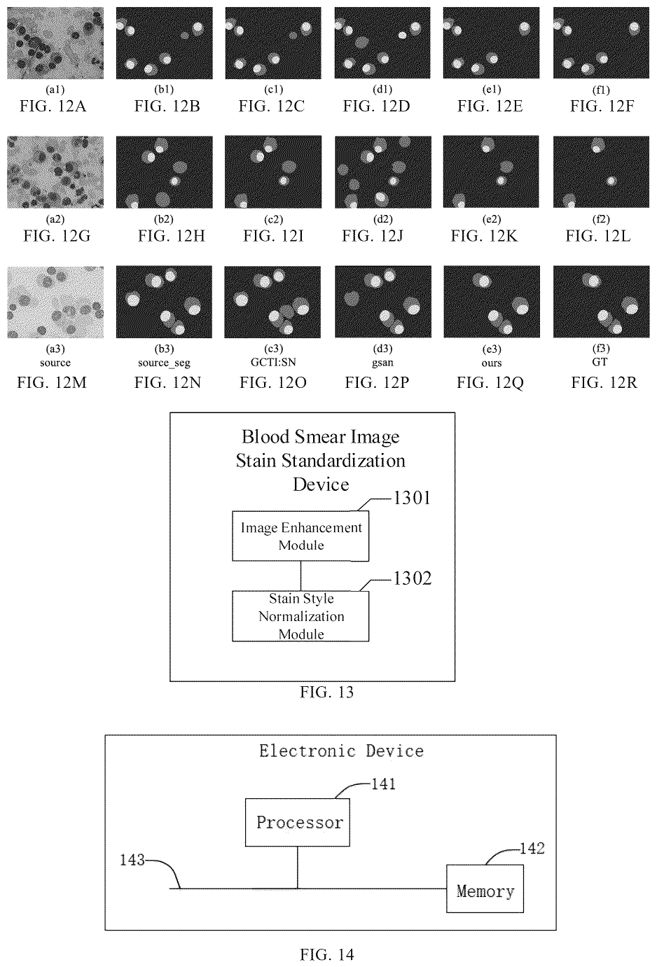

FIGS. 10A-10R, FIGS. 11A-11R, and FIGS. 12A-12R visualize the segmentation results for cells, nuclei, and myeloma plasma cells. As shown in FIGS. 12A-12R, FIG. 12I yields higher accuracy than FIG. 12H, while FIG. 12O performs worse than FIG. 12N. This indicates that the effectiveness of GCTI:SN's illumination correction highly depends on reference image quality: illumination correction improves performance when the reference is of higher quality than the input, but may degrade performance otherwise. In contrast, FIG. 12J performs worse than FIG. 12H, while FIG. 12P surpasses FIG. 12N, demonstrating that gsan performs well on high-quality images but degrades significantly when handling low-quality images. After standardization using the proposed method, segmentation performance improves considerably, further validating the effectiveness of the decoupled strategy. Particularly, the low-quality image enhancement network plays an essential role before stain unification, mitigating performance limitations faced by both GCTI:SN and gsan.

In summary, the present embodiment proposes a decoupled deep attention model for stain normalization in blood smear images. This model effectively achieves stain normalization, with its key technical contributions summarized as follows:

### 1. A Decoupled Deep Attention Model for Stain Normalization in Blood Smear Images is Proposed.

The stain normalization task is divided into two separate stages: low-quality image enhancement and stain style unification. Two subnetworks, Net1 and Net2, are designed to handle these subtasks individually. This decomposition significantly reduces the difficulty of stain normalization and overcomes performance bottlenecks associated with existing methods that treat degradation and standardization jointly.

### 2. Net1 Integrates the Retinex Model, Transformer, and Mamba to Form the RetinexMambaFormer Framework.

This framework preserves the Transformer's ability to model long-range dependencies and non-local interactions while leveraging Mamba's selective state mechanisms to achieve linear-complexity global and local attention. This is the first attempt to combine Transformer and Mamba for low-quality image enhancement.

### 3. Net2 Constructs an Attention-Based Laplacian Pyramid Generative Network.

This design eliminates the reliance on domain labels commonly associated with GAN-based standardization methods. A residual attention mechanism is employed in the low-resolution residual network to prevent information loss in deep layers and enable adaptive weight adjustment. Additionally, a channel attention-based style network is designed to reallocate channel weights and enhance stain contour extraction, thereby improving stain normalization performance.

FIG. 13 illustrates a structural schematic of the blood smear stain normalization device provided in the present embodiment. The device includes:

### Image Enhancement Module 1301

Configured to:
acquire a blood smear image and an illumination prior map;
merge the illumination prior map into the blood smear image to simulate interactions among regions under different illumination conditions;
extract an illumination feature map and aggregate it to generate an illumination map;
enhance the blood smear image using the illumination map to obtain a first image;
generate an enhanced image based on the first image and the illumination feature map.

### Stain Style Unification Module 1302

Configured to:
decompose the enhanced image into a set of octave-spaced bandpass images and one low-resolution residual image;
extract features from the low-resolution residual image to obtain a first feature map;
extract a first morphological representation and staining contour from the first feature map and combine them to produce a standardized low-resolution residual image;
extract a second morphological representation from the bandpass images and combine it with the staining contour to generate standardized bandpass images.

In some embodiments, the image enhancement module is further configured to:
merge the blood smear image with the illumination prior map, fuse the illumination prior map into the blood smear image using a pointwise convolution, simulate interactions among regions under different illumination conditions using depthwise separable convolutions, further extract features, and generate an illumination feature map Fₗᵤ;
aggregate the illumination feature map Fₗᵤ using a pointwise convolution to generate an illumination map;
decompose the blood smear image into a reflectance component and an illumination component according to the following equation:

$$S = R ∘ I \qquad ( 1 )$$

where S denotes the blood smear image, R denotes the reflectance component, I denotes the illumination component, and “∘” denotes element-wise multiplication;
introduce perturbations to the reflectance and illumination components within the blood smear image to obtain an intermediate image, expressed as:

$$S 1 = ( R + \hat{R} ) ∘ ( I + \hat{I} ) = R ∘ I + R ∘ \hat{I} + \hat{R} ∘ ( I + \hat{I} ) \qquad ( 2 )$$

where S1 denotes the intermediate image, \hat{R} denotes the perturbation of the reflectance component, and Î denotes the perturbation of the illumination component;
multiply the intermediate image by the illumination map to obtain:

$$S ◦ \overline{I} = R + R ◦ ( \hat{I} ◦ \overline{I} ) + ( \hat{R} ◦ ( I + \hat{I} ) ) ◦ \overline{I} \qquad ( 3 )$$

where Ī denotes the illumination map, Ī∘I=1;
the term \hat{R}∘(I+Î) represents amplified noise and artifacts introduced during the brightening process of underexposed regions, and the term R∘(Î∘Ī) represents under-exposure, over-exposure, and/or color distortion caused during the brightening process;
simplify Equation (3) to obtain:

$${S}_{lu} = S ∘ \overline{I} = R + C \qquad ( 4 )$$

where Sₗᵤ denotes the first image.

In some embodiments, the image enhancement module is further configured to compute:

$${I}_{e n} = g ( {S}_{lu} , {F}_{lu} ) \qquad ( 5 )$$

where g denotes a degradation restoration unit, Iₑₙ denotes the enhanced image, Sₗᵤ denotes the first image, and Fₗᵤ denotes the illumination feature map.

In some embodiments, the degradation restoration unit includes an encoder and a decoder.

The encoder is configured to downsample the input Sₗᵤ to match the dimensions of Fₗᵤ reduce computational complexity during downsampling, and perform deep feature extraction. The downsampling process includes a first level and a second level, each including an IFMT module and a 4×4 convolution module. After the first and second levels of downsampling, an intermediate feature map is obtained.

The decoder is configured to upsample the intermediate feature map. The upsampling process includes a third level and a fourth level, each including a 2×2 deconvolution (dconv) module, a 1×1 convolution module, and an IFMT module. The output of each 2×2 deconvolution module is concatenated with the output of the corresponding IFMT module from the downsampling stage to mitigate information loss. After the third and fourth upsampling levels, a second feature map is obtained, and its dimensions are adjusted back to RGB three channels to obtain a restored image. The restored image is added to the first image through a residual connection to obtain the enhanced image.

In some embodiments, the IFMT module includes a first multi-head self-attention mechanism, a second multi-head self-attention mechanism, layer normalization, a feedforward network, and residual connections.

### Processing of the First Multi-Head Self-Attention Mechanism

The input feature Fᵢₙ is reshaped into a feature X.

The feature X is divided into k heads according to the following formula:

$$X = [ {X}_{1} , {X}_{2} , … , {X}_{i} , … , {X}_{k} ] \qquad ( 6 )$$

where Xᵢ denotes the feature of the i-th head,

$${X}_{i} ∈ {ℝ}^{H W \times {d}_{k}} , {d}_{k} = \frac{c}{k} , i = 1 , 2 , … , k , ℝ$$

denotes real numbers, H denotes image height, W denotes image width, and C denotes the number of channels.

For each head, three bias-free fully connected layers linearly project Xᵢ into Qᵢ∈ [symbol] ^{HW×d}^{ₖ}, Kᵢ∈ [symbol] ^{HW×d}^{ₖ}, Vᵢ∈ [symbol] ^{HW×d}^{ₖ}:

$${Q}_{i} = {X}_{i} {W}_{{Q}_{i}}^{T} , {K}_{i} = {X}_{i} {W}_{{K}_{i}}^{T} , {V}_{i} = {X}_{i} {W}_{{V}_{i}}^{T} \qquad ( 7 )$$

W_{Q}_{ᵢ}, W_{K}_{ᵢ}, W_{V}_{ᵢ}∈ [symbol] ^{d}^{ₖ}^{×d}^{ₖ} are learnable weights, and T denotes matrix transposition.

To enhance interactions between regions of different exposure levels, the illumination feature map Fₗᵤ is used as guidance for self-attention. Fₗᵤ is reshaped into feature Y∈ [symbol] ^{HW×C} and divided into k heads:

$$Y = [ {Y}_{1} , {Y}_{2} , … , {Y}_{i} , … , {Y}_{k} ] \qquad ( 8 )$$

wherein Yᵢ denotes the feature of the i-th head, Yᵢ∈ [symbol] ^{HW×d}^{ₖ}, i=1, 2, . . . , k

For each headᵢ, self-attention is expressed as:

$$Attention ( {Q}_{i} , {K}_{i} , {V}_{i} , {Y}_{i} ) = ( {Y}_{i} ∘ {V}_{i} ) softmax \frac{{K}_{i}^{T} {Q}_{i}}{{α}_{i}} ) \qquad ( 9 )$$

where αᵢ− [symbol] ¹ is a learnable scaling parameter.

The outputs of all k heads are concatenated and passed through a fully connected layer, and positional encoding P∈ [symbol] ^{HW×C} is added to obtain an output token Xₒᵤₜ∈ [symbol] ^{HW×C}.
Xₒᵤₜ is reshaped to obtain the output feature Fₒᵤₜ∈ [symbol] ^{H×W×C}.

### Processing of the Second Multi-Head Self-Attention Mechanism (Vision Mamba)

The input feature is processed through a Linear layer and a depthwise separable convolution, activated by a SiLU function, and expanded using 2D scanning from four directions (top, bottom, left, right). After flattening the image, height and width are merged into a token sequence. Each sequence is fed into a feature extraction module for global feature extraction, computed as:

$${h}_{t} = \overline{A} {h}_{t - 1} + \overline{B} {x}_{t}$$

$${y}_{t} = \overline{C} {h}_{t}$$

where xₜ is the input feature, yₜ is the output feature, Ā, B̅, C̅ are learnable parameters, and hₜ is the state vector at time step t.

Outputs y₁, y₂, y₃, y₄ from the four scanning directions are summed and merged, and the feature map is reshaped back to the same spatial dimensions as the input feature.

The number of hidden layers in the 2D scanning process is doubled gradually as the IFMT level increases, enabling extraction of deeper features from vectors containing integrated illumination features.

In some embodiments, the staining-style unification module is further configured to: construct a low-resolution residual network and a style network.

The low-resolution residual network is configured to perform feature extraction on the low-resolution residual image to obtain a first feature map, extract a first morphological representation from the first feature map, and combine the first morphological representation with a staining contour to obtain a standardized low-resolution residual image.

The style network is configured to extract the staining contour from the first feature map.

The low-resolution residual network obtains the standardized low-resolution residual image through the following method:
acquiring a low-resolution residual image; extracting features using two conv 3×3 units and a LeakyReLU unit; performing deeper-level feature extraction through two residual self-attention modules; and finally obtaining the first feature map through a conv 3×3 unit; extracting the first morphological representation from the first feature map using a conv 3×3 unit, an InstanceNorm2d unit, a LinearBlock unit, and a LeakyReLU unit; combining the first morphological representation with the staining contour extracted by the style network and feeding the result into a generator, which performs processing through two residual self-attention modules, followed by a conv 3×3 unit, a LeakyReLU unit, and two conv 3×3 units, to obtain the standardized low-resolution residual image (Î₃).

The style network includes an encoder module and a decoder module, and extracts the staining contour from the first feature map through the following process:
in the encoder module, performing transformation on the first feature map using a Color Transform module designed with conv 1×1, BatchNorm2d, and ReLU, to enhance color consistency of the input features and reduce the influence of non-target style features on style-vector generation;
compressing spatial dimensions using AdaptiveAvgPool2d to obtain a global feature representation; during the generation of the global feature representation, introducing a channel-attention mechanism to adaptively adjust channel importance, enabling the network to focus on features that significantly contribute to style information;
the output of the encoder module includes a mean and variance, which are used by a VAE to generate a style-feature vector;
in the decoder module, reconstructing the style-feature vector through a fully connected layer and further applying nonlinear transformation via an activation function to generate adaptive instance-normalization parameters (αᵢ, βᵢ) representing the staining contour.

The blood-smear image staining-normalization apparatus provided in the embodiments of the present application may be used to execute the technical solution of the blood-smear image staining-normalization method described above. The implementation principles and technical effects are similar and thus will not be repeated.

FIG. 14 is a schematic structural diagram of an electronic device according to an embodiment of the present application. As shown in FIG. 14, the electronic device may include a processor 141 and a memory 142, wherein the processor 141 and the memory 142 are capable of communicating with each other; illustratively, the processor 141 and the memory 142 communicate via a communication bus 143.

The processor 141 executes computer-executable instructions stored in the memory 142 such that the processor 141 implements the above-described solutions. The processor 141 may be a general-purpose processor, including a Central Processing Unit (CPU), a Network Processor (NP), or the like; or a Digital Signal Processor (DSP), an Application-Specific Integrated Circuit (ASIC), a Field-Programmable Gate Array (FPGA), another programmable logic device, discrete gate or transistor logic device, or discrete hardware component.

The communication bus 143 may be a Peripheral Component Interconnect (PCI) bus, an Extended Industry Standard Architecture (EISA) bus, or the like. The system bus may include an address bus, a data bus, and a control bus. For convenience, only one thick line is illustrated in the figure, which does not imply that there is only one bus or one type of bus.

A transceiver may be used to implement communication between the database-access device and other computers (e.g., clients, read-write databases, and read-only databases).

The memory may include Random Access Memory (RAM) and may also include non-volatile memory.

The electronic device provided in the embodiments of the present application may be the terminal device described above.

The embodiments of the present application further provide a computer-readable storage medium storing computer instructions which, when executed on a computer, cause the computer to implement the technical solution of the blood-smear image staining-normalization method described in the above embodiments.

The embodiments of the present application further provide a computer program product including a computer program stored on a computer-readable storage medium. When executed by at least one processor reading the program from the computer-readable storage medium, the program enables implementation of the blood-smear image staining-normalization method described above.

In the several embodiments provided in the present application, it should be understood that the disclosed devices and methods may be implemented in various ways. For example, the device embodiments described above are merely illustrative. The division of modules is based solely on logical functional partitioning, and alternative divisions may be adopted in actual implementation—multiple modules may be combined or integrated into another system, certain features may be omitted, or not executed.

Additionally, the coupling, direct coupling, or communication connections shown or discussed may be achieved through certain interfaces, indirect coupling, or communication between devices or modules using electrical, mechanical, or other forms.

Modules described as separate components may or may not be physically separate. Components shown as modules may or may not be independent physical units; they may reside in a single location or be distributed across multiple network units. Portions or all modules may be selected based on practical needs to implement the embodiments.

Furthermore, the functional modules described in the embodiments may be integrated into a single processing unit, implemented as independent physical modules, or two or more modules may be integrated into one unit. These modules may be implemented in hardware or as a combination of hardware and software functional units.

The integrated modules implemented as software functional units may be stored in a computer-readable storage medium. The software functional modules stored in the storage medium include instructions configured to enable a computer device (such as a personal computer, server, or network device) or a processor to execute some steps of the methods of the present application.

It should be understood that the processor described above may be a Central Processing Unit (CPU), a general-purpose processor, a Digital Signal Processor (DSP), an Application-Specific Integrated Circuit (ASIC), or the like. The general-purpose processor may be a microprocessor or any conventional processor. The steps of the methods disclosed herein may be implemented directly by hardware processing or by a combination of hardware and software modules within the processor.

The memory may include high-speed RAM and may also include non-volatile memory such as at least one disk memory. It may also include a USB flash drive, mobile hard disk, Read-Only Memory (ROM), magnetic disk, or optical disk.

The bus may be an Industry Standard Architecture (ISA) bus, a Peripheral Component Interconnect (PCI) bus, or an Extended Industry Standard Architecture (EISA) bus. The bus may include an address bus, data bus, and control bus. For simplicity, the bus shown in the figures does not limit the number or type of buses.

The storage medium may be implemented using any type of volatile or non-volatile memory device, or a combination thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, magnetic disk, or optical disk.

The storage medium may be any accessible medium that can be read by a general-purpose or dedicated computer.

An exemplary storage medium may be coupled to the processor to allow the processor to read information from and write information to the storage medium. The storage medium may also be integrated with the processor. The processor and storage medium may be integrated into an ASIC. Alternatively, the processor and storage medium may exist as discrete components in an electronic control unit or a master controller.

Those skilled in the art will understand that all or part of the steps of the method embodiments may be completed by hardware associated with program instructions. The program may be stored on a computer-readable storage medium. When executed, the program performs the steps of the method embodiments.

The computer-readable storage medium may include ROM, RAM, magnetic disks, optical disks, or any medium capable of storing program code.

Finally, it should be noted that the above embodiments are merely intended to illustrate the technical solutions of the present application and not to limit them. Although the present application has been described in detail with reference to the foregoing embodiments, those of ordinary skill in the art will appreciate that various modifications or equivalent substitutions may be made to the technical solutions described in the embodiments, without departing from the essence of the technical solutions. All such modifications and substitutions shall fall within the scope of the embodiments of the present application.

What is claimed is:

1. A blood smear image staining normalization method, comprising:
acquiring a blood smear image and an illumination prior map, merging the illumination prior map into the blood smear image, simulating interactions between regions under different illumination conditions, extracting an illumination feature map, aggregating the illumination feature map to generate an illumination map, and enhancing the blood smear image by using the illumination map to obtain a first image;
obtaining an enhanced image according to the first image and the illumination feature map;
decomposing the enhanced image into a set of octave-spaced band-pass images and a low-resolution residual layer image;
performing feature extraction on the low-resolution residual layer image to obtain a first feature map, extracting a first morphological representation and a staining contour according to the first feature map, and combining the first morphological representation with the staining contour to obtain a normalized low-resolution residual layer image;
performing feature extraction on the set of octave-spaced band-pass images to obtain a second morphological representation, and combining the second morphological representation with the staining contour to obtain a normalized band-pass image.

2. The blood smear image staining normalization method according to claim 1, wherein acquiring the blood smear image and the illumination prior map, merging the illumination prior map into the blood smear image, simulating interactions between regions under different illumination conditions, extracting the illumination feature map, aggregating the illumination feature map to generate the illumination map, and enhancing the blood smear image by using the illumination map to obtain the first image comprises:
merging the blood smear image with the illumination prior map, embedding the illumination prior map into the blood smear image using pointwise convolution, simulating interactions between regions under different illumination conditions using depthwise separable convolution, and further extracting features to generate an illumination feature map Fₗᵤ;
aggregating the illumination feature map Fₗᵤ using pointwise convolution to generate the illumination map;
decomposing the blood smear image into a reflectance component and an illumination component according to the following formula:
$$S = R ∘ I \qquad ( 1 )$$
wherein S denotes the blood smear image, R denotes the reflectance component, I denotes the illumination component, and ∘ denotes element-wise multiplication;
introducing perturbations of the reflectance component and the illumination component into the blood smear image to obtain an intermediate image expressed as:
$$S 1 = ( R + \hat{R} ) ∘ ( I + \hat{I} ) = R ∘ I + R ∘ \hat{I} + \hat{R} ∘ ( I + \hat{I} ) \qquad ( 2 )$$
wherein S1 denotes the intermediate image, \hat{R} denotes a perturbation of the reflectance component, and Î denotes a perturbation of the illumination component;
multiplying the intermediate image by the illumination map to obtain:
$$S ∘ \overline{I} = R + R ∘ ( \hat{I} ∘ \overline{I} ) + ( \hat{R} ∘ ( I + \hat{I} ) ) ∘ \overline{I} \qquad ( 3 )$$
wherein Ī denotes the illumination map, Ī∘I=1; \hat{R}∘(I+Î) represents amplified noise and artifacts produced in an enhancement process of a low-exposure image, and R∘(Î∘Ī) represents under-exposure, over-exposure, and/or color distortion introduced during the enhancement process;
simplification of Equation (3) is obtained as follows:
$${S}_{Iu} = S ∘ \overline{I} = R + C \qquad ( 4 )$$
wherein Sₗᵤ denotes the first image.

3. The blood smear image staining normalization method according to claim 1, wherein the enhanced image is obtained from the first image and the illumination feature map according to the following formula:
$${I}_{e n} = g ( {S}_{Iu} , {F}_{Iu} ) \qquad ( 5 )$$
wherein g denotes a corruption restorer, Iₑₙ denotes the enhanced image, Sₗᵤ denotes the first image, and Fₗᵤ denotes the illumination feature map.

4. The blood smear image staining normalization method according to claim 3, wherein the corruption restorer comprises an encoder and a decoder;
wherein the encoder is configured to downsample input Sₗᵤ to match a dimensionality of Fₗᵤ, reduce computational complexity through downsampling, and extract deep features, the downsampling comprising a first level and a second level, each including an Illumination-Fused Mamba and Transformer (IFMT) module and a 4×4 convolution module, and a middle feature map is obtained after the first and second downsampling levels;
the decoder is configured to perform upsampling on the middle feature map, the upsampling comprising a third level and a fourth level, each including a 2×2 deconvolution module, a 1×1 convolution module, and an IFMT module, wherein an output of each deconvolution module is concatenated with an output of the IFMT module in a corresponding downsampling level to compensate for information loss; after the third and fourth upsampling levels, a second feature map is obtained, a dimensionality of the second feature map is restored to RGB channels to obtain a restored image, and the restored image is residually connected with the first image to obtain the enhanced image.

5. The blood smear image staining normalization method according to claim 4, wherein the IFMT module comprises a first multi-head self-attention mechanism, a second multi-head self-attention mechanism, layer normalization, a feed-forward network, and residual connections;
wherein the first multi-head self-attention mechanism processes input features Fᵢₙ by reshaping Fᵢₙ into feature X and splitting X into k heads according to:
$$X = [ {X}_{1} , {X}_{2} , … , {X}_{i} , … , {X}_{k} ] \qquad ( 6 )$$
wherein Xᵢ denotes a feature of an i-th head,
$${X}_{i} ∈ {ℝ}^{H W \times {d}_{k}} , {d}_{k} = \frac{c}{k} , i = 1 , 2 , … , k ;$$ [symbol]
represents a set of real numbers; H denotes an image height; W denotes an image width; dₖ denotes a feature dimension of each head; and C denotes a number of channels;
for each headᵢ, three bias-free fully connected layers are used to linearly project Xᵢ into Qᵢ∈ [symbol] ^{HW×d}^{ₖ}, Kᵢ∈ [symbol] ^{HW×d}^{ₖ}, Vᵢ∈ [symbol] ^{HW×d}^{ₖ},
$${Q}_{i} = {X}_{i} \cdot {W}_{{Q}_{i}}^{T} , {K}_{i} = {X}_{i} \cdot {W}_{{K}_{i}}^{T} , {V}_{i} = {X}_{i} {W}_{{V}_{i}}^{T} \qquad ( 7 )$$
wherein W_{Q}_{ᵢ}, W_{K}_{ᵢ}, W_{V}_{ᵢ}∈ [symbol] ^{d}^{ₖ}^{×d}^{ₖ} are learnable parameters of fully connected layers; T denotes matrix transpose; and Qᵢ, Kᵢ, Vᵢ correspond to query, key, and value, respectively;
the illumination feature map Fₗᵤ is used as guidance for computing self-attention to enhance interactions between regions of different exposure levels, Fₗᵤ is reshaped into a feature matrix Y∈ [symbol] ^{HW×C}, and Y is divided into k heads:
$$Y = [ {Y}_{1} , {Y}_{2} , … , {Y}_{i} , … , {Y}_{k} ] \qquad ( 8 )$$
wherein Yᵢ denotes the feature of the i-th head, Yᵢ∈ [symbol] ^{HW×d}^{ₖ}, i=1, 2, . . . , k;
self-attention of each headᵢ is defined as:
$$Attention ( {Q}_{i} , {K}_{i} , {V}_{i} , {Y}_{i} ) = ( {Y}_{i} ∘ {V}_{i} ) softmax ( \frac{{K}_{i}^{T} {Q}_{i}}{{α}_{i}} ) \qquad ( 9 )$$
wherein αᵢ∈ [symbol] ¹ is a learnable parameter used for adaptive scaling of matrix multiplication; Attention denotes a multi-head self-attention processing function; and softmax denotes a softmax operation;
the outputs of the k heads are concatenated and passed through a fully connected layer, and positional encoding P∈ [symbol] ^{HW×C} is added to obtain an output token Xₒᵤₜ∈ [symbol] ^{HW×C}; reshaping Xₒᵤₜ yields an output feature Fₒᵤₜ∈ [symbol] ^{H×W×C};
the input features are processed through a Linear layer and depthwise separable convolution, followed by a SiLU activation function, a 2D scanning operation extends along four directions comprising top, bottom, left, and right, a height and a width of a flattened image are merged into a token sequence, each sequence from scanning is fed into a feature extraction module for global feature extraction, which is computed as:
$${h}_{t} = \overline{A} {h}_{t - 1} + \overline{B} {x}_{t}$$
$${y}_{t} = \overline{C} {h}_{t}$$
wherein xₜ denotes the input feature, yₜ denotes an output feature, Ā, B̅, and C̅ are learnable parameters, and hₜ is a state vector at time step t;
outputs y₁, y₂, y₃, and y₄ from the four directions are summed and merged, and an output feature size is adjusted to match a size of the input feature;
a number of hidden layers in a 2D scanning module is configured to double as IFMT level increases, allowing progressively deeper feature extraction from a vector containing integrated illumination features.

6. The blood smear image staining normalization method according to claim 1, wherein performing feature extraction on the low-resolution residual layer image to obtain the first feature map, extracting the first morphological representation and the staining contour, and combining the first morphological representation with the staining contour to obtain the normalized low-resolution residual layer image comprises:
constructing a low-resolution residual network and a style network;
wherein the low-resolution residual network extracts the first feature map from the low-resolution residual layer image, extracts the first morphological representation, and combines the first morphological representation with the staining contour to generate the normalized low-resolution residual layer image; and the style network extracts the staining contour from the first feature map;
the low-resolution residual network obtains the normalized low-resolution residual layer image by:
acquiring the low-resolution residual layer image, extracting features with two 3×3 convolution units and a LeakyReLU unit, performing deeper feature extraction with two residual self-attention modules, and generating the first feature map using a 3×3 convolution unit;
extracting the first morphological representation using a 3×3 convolution unit, an InstanceNorm2d unit, a LinearBlock unit, and a LeakyReLU unit, combining the first morphological representation with the staining contour extracted by the style network, and feeding a combined representation to a generator comprising two residual self-attention modules and three 3×3 convolution units to obtain a normalized low-resolution residual layer image (Î₃);
the style network comprises an encoder and a decoder, the encoder using a Color Transform module comprising conv 1×1, BatchNorm2d, and ReLU to normalize color features, using AdaptiveAvgPool2d with channel attention to produce a global representation with mean and variance, and generating a style vector through a VAE; the decoder reconstructs the style vector using a fully connected layer and activation to generate adaptive instance normalization parameters (αᵢ, βᵢ) representing the staining contour.

7. A blood smear image staining normalization apparatus, comprising:
an image enhancement module configured to acquire a blood smear image and an illumination prior map, merge the illumination prior map into the blood smear image, simulate interactions between regions under different illumination conditions, extract an illumination feature map, aggregate the illumination feature map to generate an illumination map, enhance the blood smear image to obtain a first image, and obtain an enhanced image according to the first image and the illumination feature map;
a staining style unification module configured to decompose the enhanced image into a set of octave-spaced band-pass images and a low-resolution residual layer image, perform feature extraction on the low-resolution residual layer image to obtain a first morphological representation and staining contour, generate a normalized low-resolution residual layer image, perform feature extraction on the set of octave-spaced band-pass images to obtain a second morphological representation, and combine the second morphological representation with the staining contour to obtain a normalized band-pass image.

8. An electronic device, comprising a processor and a memory in communication with the processor; wherein
the memory stores computer-executable instructions;
the processor executes the computer-executable instructions to implement the blood smear image staining normalization method according to claim 1.

9. A computer-readable storage medium, wherein the computer-readable storage medium stores computer-executable instructions which, when executed by a processor, implement the blood smear image staining normalization method according to claim 1.

10. A computer program product, wherein the computer program product comprises program instructions which, when executed by a processor, implement the blood smear image staining normalization method according to claim 1.

11. The electronic device according to claim 8, wherein in the blood smear image staining normalization method, the acquiring the blood smear image and the illumination prior map, merging the illumination prior map into the blood smear image, simulating interactions between regions under different illumination conditions, extracting the illumination feature map, aggregating the illumination feature map to generate the illumination map, and enhancing the blood smear image by using the illumination map to obtain the first image comprises:
merging the blood smear image with the illumination prior map, embedding the illumination prior map into the blood smear image using pointwise convolution, simulating interactions between regions under different illumination conditions using depthwise separable convolution, and further extracting features to generate an illumination feature map Fₗᵤ;
aggregating the illumination feature map Fₗᵤ using pointwise convolution to generate the illumination map;
decomposing the blood smear image into a reflectance component and an illumination component according to the following formula:
$$S = R ∘ I \qquad ( 1 )$$
wherein S denotes the blood smear image, R denotes the reflectance component, I denotes the illumination component, and ∘ denotes element-wise multiplication;
introducing perturbations of the reflectance component and the illumination component into the blood smear image to obtain an intermediate image expressed as:
$$S 1 = ( R + \hat{R} ) ∘ ( I + \hat{I} ) = R ∘ I + R ∘ \hat{I} + \hat{R} ∘ ( I + \hat{I} ) \qquad ( 2 )$$
wherein S1 denotes the intermediate image, \hat{R} denotes a perturbation of the reflectance component, and Î denotes a perturbation of the illumination component;
multiplying the intermediate image by the illumination map to obtain:
$$S ∘ \overline{I} = R + R ∘ ( \hat{I} ∘ \overline{I} ) + ( \hat{R} ∘ ( I + \hat{I} ) ) ∘ \overline{I} \qquad ( 3 )$$
wherein Ī denotes the illumination map, Ī∘I=1; \hat{R}∘(I+Î) represents amplified noise and artifacts produced in an enhancement process of a low-exposure image, and R∘(Î∘Ī) represents under-exposure, over-exposure, and/or color distortion introduced during the enhancement process;
simplification of Equation (3) is obtained as follows:
$${S}_{lu} = S ∘ \overline{I} = R + C \qquad ( 4 )$$
wherein Sₗᵤ denotes the first image.

12. The electronic device according to claim 8, wherein in the blood smear image staining normalization method, the enhanced image is obtained from the first image and the illumination feature map according to the following formula:
$${I}_{e n} = g ( {S}_{lu} , {F}_{lu} ) \qquad ( 5 )$$
wherein g denotes a corruption restorer, Iₑₙ denotes the enhanced image, Sₗᵤ denotes the first image, and Fₗᵤ denotes the illumination feature map.

13. The electronic device according to claim 12, wherein in the blood smear image staining normalization method, the corruption restorer comprises an encoder and a decoder;
wherein the encoder is configured to downsample input Sₗᵤ to match a dimensionality of Fₗᵤ, reduce computational complexity through downsampling, and extract deep features, the downsampling comprising a first level and a second level, each including an IFMT module and a 4×4 convolution module, and a middle feature map is obtained after the first and second downsampling levels;
the decoder is configured to perform upsampling on the middle feature map, the upsampling comprising a third level and a fourth level, each including a 2×2 deconvolution module, a 1×1 convolution module, and an IFMT module, wherein an output of each deconvolution module is concatenated with an output of the IFMT module in a corresponding downsampling level to compensate for information loss; after the third and fourth upsampling levels, a second feature map is obtained, a dimensionality of the second feature map is restored to RGB channels to obtain a restored image, and the restored image is residually connected with the first image to obtain the enhanced image.

14. The electronic device according to claim 13, wherein in the blood smear image staining normalization method, the IFMT module comprises a first multi-head self-attention mechanism, a second multi-head self-attention mechanism, layer normalization, a feed-forward network, and residual connections;
wherein the first multi-head self-attention mechanism processes input features Fᵢₙ by reshaping Fᵢₙ into feature X and splitting X into k heads according to:
$$X = [ {X}_{1} , {X}_{2} , … , {X}_{i} , … , {X}_{k} ] \qquad ( 6 )$$
wherein Xᵢ denotes a feature of an i-th head, Xᵢ∈ [symbol] ^{HW×d}^{ₖ},
$${d}_{k} = \frac{c}{k} , i = 1 , 2 , … , k ;$$ [symbol]
represents a set of real numbers; H denotes an image height; W denotes an image width; dₖ denotes a feature dimension of each head; and C denotes a number of channels;
for each headᵢ, three bias-free fully connected layers are used to linearly project Xᵢ into Qᵢ∈ [symbol] ^{HW×d}^{ₖ}, Kᵢ∈ [symbol] ^{HW×d}^{ₖ}, Vᵢ∈ [symbol] ^{HW×d}^{ₖ},
$${Q}_{i} = {X}_{i} {W}_{{Q}_{i}}^{T} , \qquad ( 7 )$$
$${K}_{i} = {X}_{i} {W}_{{K}_{i}}^{T} ,$$
$${V}_{i} = {X}_{i} {W}_{{V}_{i}}^{T}$$
wherein W_{Q}_{ᵢ}, W_{K}_{ᵢ}, W_{V}_{ᵢ}∈ [symbol] ^{d}^{ₖ}^{×d}^{ₖ} are learnable parameters of fully connected layers;
T denotes matrix transpose; and Qᵢ, Kᵢ, Vᵢ correspond to query, key, and value, respectively;
the illumination feature map Fₗᵤ is used as guidance for computing self-attention to enhance interactions between regions of different exposure levels, Fₗᵤ is reshaped into a feature matrix Y∈ [symbol] ^{HW×C}, and Y is divided into k heads:
$$Y = [ {Y}_{1} , {Y}_{2} , … , {Y}_{i} , … , {Y}_{k} ] \qquad ( 8 )$$
wherein Yᵢ denotes the feature of the i-th head, Yᵢ∈ [symbol] ^{HW×d}^{ₖ}, i=1, 2, . . . , k;
self-attention of each headᵢ is defined as:
$$Attention ( {Q}_{i} , {K}_{i} , {V}_{i} , {Y}_{i} ) = ( {Y}_{i} ∘ {V}_{i} ) softmax ( \frac{{K}_{i}^{T} {Q}_{i}}{{α}_{i}} ) \qquad ( 9 )$$
wherein αᵢ∈ [symbol] ¹ is a learnable parameter used for adaptive scaling of matrix multiplication; Attention denotes a multi-head self-attention processing function; and softmax denotes a softmax operation;
the outputs of the k heads are concatenated and passed through a fully connected layer, and positional encoding P∈ [symbol] ^{HW×C} is added to obtain an output token Xₒᵤₜ∈ [symbol] ^{HW×C};
reshaping Xₒᵤₜ yields an output feature Fₒᵤₜ∈ [symbol] ^{H×W×C};
the input features are processed through a Linear layer and depthwise separable convolution, followed by a SiLU activation function, a 2D scanning operation extends along four directions comprising top, bottom, left, and right, a height and a width of a flattened image are merged into a token sequence, each sequence from scanning is fed into a feature extraction module for global feature extraction, which is computed as:
$${h}_{t} = \overline{A} {h}_{t - 1} + \overline{B} {x}_{t}$$
$${y}_{t} = \overline{C} {h}_{t}$$
wherein xₜ denotes the input feature, yₜ denotes an output feature, Ā, B̅, and C̅ are learnable parameters, and hₜ is a state vector at time step t;
outputs y₁, y₂, y₃, and y₄ from the four directions are summed and merged, and an output feature size is adjusted to match a size of the input feature;
a number of hidden layers in a 2D scanning module is configured to double as IFMT level increases, allowing progressively deeper feature extraction from a vector containing integrated illumination features.

15. The electronic device according to claim 8, wherein in the blood smear image staining normalization method, performing feature extraction on the low-resolution residual layer image to obtain the first feature map, extracting the first morphological representation and the staining contour, and combining the first morphological representation with the staining contour to obtain the normalized low-resolution residual layer image comprises:
constructing a low-resolution residual network and a style network;
wherein the low-resolution residual network extracts the first feature map from the low-resolution residual layer image, extracts the first morphological representation, and combines the first morphological representation with the staining contour to generate the normalized low-resolution residual layer image; and the style network extracts the staining contour from the first feature map;
the low-resolution residual network obtains the normalized low-resolution residual layer image by:
acquiring the low-resolution residual layer image, extracting features with two 3×3 convolution units and a LeakyReLU unit, performing deeper feature extraction with two residual self-attention modules, and generating the first feature map using a 3×3 convolution unit;
extracting the first morphological representation using a 3×3 convolution unit, an InstanceNorm2d unit, a LinearBlock unit, and a LeakyReLU unit, combining the first morphological representation with the staining contour extracted by the style network, and feeding a combined representation to a generator comprising two residual self-attention modules and three 3×3 convolution units to obtain a normalized low-resolution residual layer image (Î₃);
the style network comprises an encoder and a decoder, the encoder using a Color Transform module comprising conv 1×1, BatchNorm2d, and ReLU to normalize color features, using AdaptiveAvgPool2d with channel attention to produce a global representation with mean and variance, and generating a style vector through a VAE; the decoder reconstructs the style vector using a fully connected layer and activation to generate adaptive instance normalization parameters (αᵢ, βᵢ) representing the staining contour.

16. The computer-readable storage medium according to claim 9, wherein in the blood smear image staining normalization method, the acquiring the blood smear image and the illumination prior map, merging the illumination prior map into the blood smear image, simulating interactions between regions under different illumination conditions, extracting the illumination feature map, aggregating the illumination feature map to generate the illumination map, and enhancing the blood smear image by using the illumination map to obtain the first image comprises:
merging the blood smear image with the illumination prior map, embedding the illumination prior map into the blood smear image using pointwise convolution, simulating interactions between regions under different illumination conditions using depthwise separable convolution, and further extracting features to generate an illumination feature map Fₗᵤ;
aggregating the illumination feature map Fₗᵤ using pointwise convolution to generate the illumination map;
decomposing the blood smear image into a reflectance component and an illumination component according to the following formula:
$$S = R ∘ I \qquad ( 1 )$$
wherein S denotes the blood smear image, R denotes the reflectance component, I denotes the illumination component, and ∘ denotes element-wise multiplication;
introducing perturbations of the reflectance component and the illumination component into the blood smear image to obtain an intermediate image expressed as:
$$S 1 = ( R + \hat{R} ) ∘ ( I + \hat{I} ) = R ∘ I + R ∘ \hat{I} + \hat{R} ∘ ( I + \hat{I} ) \qquad ( 2 )$$
wherein S1 denotes the intermediate image, \hat{R} denotes a perturbation of the reflectance component, and Î denotes a perturbation of the illumination component;
multiplying the intermediate image by the illumination map to obtain:
$$S ∘ \overline{I} = R + R ∘ ( \hat{I} ∘ \overline{I} ) + ( \hat{R} ∘ ( I + \hat{I} ) ) ∘ \overline{I} \qquad ( 3 )$$
wherein Ī denotes the illumination map, Ī∘I=1; \hat{R}∘(I+Î) represents amplified noise and artifacts produced in an enhancement process of a low-exposure image, and R∘(Î∘Ī) represents under-exposure, over-exposure, and/or color distortion introduced during the enhancement process;
simplification of Equation (3) is obtained as follows:
$${S}_{lu} = S ∘ \overline{I} = R + C \qquad ( 4 )$$
wherein Sₗᵤ denotes the first image.

17. The computer-readable storage medium according to claim 9, wherein in the blood smear image staining normalization method, the enhanced image is obtained from the first image and the illumination feature map according to the following formula:
$${I}_{e n} = g ( {S}_{lu} , {F}_{lu} ) \qquad ( 5 )$$
wherein g denotes a corruption restorer, Iₑₙ denotes the enhanced image, Sₗᵤ denotes the first image, and Fₗᵤ denotes the illumination feature map.

18. The computer-readable storage medium according to claim 17, wherein in the blood smear image staining normalization method, the corruption restorer comprises an encoder and a decoder;
wherein the encoder is configured to downsample input Sₗᵤ to match a dimensionality of Fₗᵤ, reduce computational complexity through downsampling, and extract deep features, the downsampling comprising a first level and a second level, each including an IFMT module and a 4×4 convolution module, and a middle feature map is obtained after the first and second downsampling levels;
the decoder is configured to perform upsampling on the middle feature map, the upsampling comprising a third level and a fourth level, each including a 2×2 deconvolution module, a 1×1 convolution module, and an IFMT module, wherein an output of each deconvolution module is concatenated with an output of the IFMT module in a corresponding downsampling level to compensate for information loss; after the third and fourth upsampling levels, a second feature map is obtained, a dimensionality of the second feature map is restored to RGB channels to obtain a restored image, and the restored image is residually connected with the first image to obtain the enhanced image.

19. The computer-readable storage medium according to claim 18, wherein in the blood smear image staining normalization method, the IFMT module comprises a first multi-head self-attention mechanism, a second multi-head self-attention mechanism, layer normalization, a feed-forward network, and residual connections;
wherein the first multi-head self-attention mechanism processes input features Fᵢₙ by reshaping Fᵢₙ into feature X and splitting X into k heads according to:
$$X = [ {X}_{1} , {X}_{2} , ⋯ , {X}_{i} , ⋯ , {X}_{k} ] \qquad ( 6 )$$
wherein Xᵢ denotes a feature of an i-th head,
$${x}_{i} ∈ {ℝ}^{H W \times {d}_{k}} ,$$
$${d}_{k} = \frac{c}{k} ,$$
$$i = 1 , 2 , … , k ;$$ [symbol]
represents a set of real numbers; H denotes an image height; W denotes an image width; dₖ denotes a feature dimension of each head; and C denotes a number of channels;
for each headᵢ, three bias-free fully connected layers are used to linearly project Xᵢ into Qᵢ∈ [symbol] ^{HW×d}^{ₖ}, Kᵢ∈ [symbol] ^{HW×d}^{ₖ}, Vᵢ∈ [symbol] ^{HW×d}^{ₖ},
$${Q}_{i} = {X}_{i} {W}_{{Q}_{i}}^{T} , \qquad ( 7 )$$
$${K}_{i} = {X}_{i} {W}_{{K}_{i}}^{T} ,$$
$${V}_{i} = {X}_{i} {W}_{{V}_{i}}^{T}$$
wherein W_{Q}_{ᵢ}, W_{K}_{ᵢ}, W_{V}_{ᵢ}∈ [symbol] ^{d}^{ₖ}^{×d}^{ₖ} are learnable parameters of fully connected layers; T denotes matrix transpose; and Qᵢ, Kᵢ, Vᵢ correspond to query, key, and value, respectively;
the illumination feature map Fₗᵤ is used as guidance for computing self-attention to enhance interactions between regions of different exposure levels, Fₗᵤ is reshaped into a feature matrix Y∈ [symbol] ^{HW×C}, and Y is divided into k heads:
$$Y = [ {Y}_{1} , {Y}_{2} , ⋯ , {Y}_{i} , ⋯ , {Y}_{k} ] \qquad ( 8 )$$
wherein Yᵢ denotes the feature of the i-th head, Yᵢ∈ [symbol] ^{HW×d}^{ₖ}, i=1, 2, . . . , k;
self-attention of each head is defined as:
$$Attention ( {Q}_{i} , {K}_{i} , {V}_{i} , {Y}_{i} ) = ( {Y}_{i} ∘ {V}_{i} ) softmax ( \frac{{K}_{i}^{T} {Q}_{i}}{{α}_{i}} ) \qquad ( 9 )$$
wherein αᵢ∈ [symbol] ¹ is a learnable parameter used for adaptive scaling of matrix multiplication; Attention denotes a multi-head self-attention processing function; and
softmax denotes a softmax operation;
the outputs of the k heads are concatenated and passed through a fully connected layer, and positional encoding P∈ [symbol] ^{HW×C} is added to obtain an output token Xₒᵤₜ∈ [symbol] ^{HW×C};
reshaping Xₒᵤₜ yields an output feature Fₒᵤₜ∈ [symbol] ^{H×W×C};
the input features are processed through a Linear layer and depthwise separable convolution, followed by a SiLU activation function, a 2D scanning operation extends along four directions comprising top, bottom, left, and right, a height and a width of a flattened image are merged into a token sequence, each sequence from scanning is fed into a feature extraction module for global feature extraction, which is computed as:
$${h}_{t} = \overline{A} {h}_{t - 1} + \overline{B} {x}_{t}$$
$${y}_{c} = \overline{C} {h}_{t}$$
wherein xₜ denotes the input feature, yₜ denotes an output feature, Ā, B̅, and C̅ are learnable parameters, and hₜ is a state vector at time step t;
outputs y₁, y₂, y₃, and y₄ from the four directions are summed and merged, and an output feature size is adjusted to match a size of the input feature;
a number of hidden layers in a 2D scanning module is configured to double as IFMT level increases, allowing progressively deeper feature extraction from a vector containing integrated illumination features.

20. The computer-readable storage medium according to claim 9, wherein in the blood smear image staining normalization method, performing feature extraction on the low-resolution residual layer image to obtain the first feature map, extracting the first morphological representation and the staining contour, and combining the first morphological representation with the staining contour to obtain the normalized low-resolution residual layer image comprises:
constructing a low-resolution residual network and a style network;
wherein the low-resolution residual network extracts the first feature map from the low-resolution residual layer image, extracts the first morphological representation, and combines the first morphological representation with the staining contour to generate the normalized low-resolution residual layer image; and the style network extracts the staining contour from the first feature map;
the low-resolution residual network obtains the normalized low-resolution residual layer image by:
acquiring the low-resolution residual layer image, extracting features with two 3×3 convolution units and a LeakyReLU unit, performing deeper feature extraction with two residual self-attention modules, and generating the first feature map using a 3×3 convolution unit;
extracting the first morphological representation using a 3×3 convolution unit, an InstanceNorm2d unit, a LinearBlock unit, and a LeakyReLU unit, combining the first morphological representation with the staining contour extracted by the style network, and feeding a combined representation to a generator comprising two residual self-attention modules and three 3×3 convolution units to obtain a normalized low-resolution residual layer image (Î₃);
the style network comprises an encoder and a decoder, the encoder using a Color Transform module comprising conv 1×1, BatchNorm2d, and ReLU to normalize color features, using AdaptiveAvgPool2d with channel attention to produce a global representation with mean and variance, and generating a style vector through a VAE; the decoder reconstructs the style vector using a fully connected layer and activation to generate adaptive instance normalization parameters (αᵢ, βᵢ) representing the staining contour.
